(19) United States
(12) Patent Application Publication
(10) Pub. No.: US 2005/0208422 A1
(43) Pub. Date: Sep. 22, 2005

(54) Support for lithographic printing plate and presensitized plate

(75) Inventors: Atsushi Matsuura, Shizuoka (JP); Hirokazu Sawada, Shizuoka (JP); Akio Uesugi, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/081,770

(22) Filed: Mar. 17, 2005

(30) Foreign Application Priority Data
Mar. 17, 2004 (JP) 2004-075759

(51) Int. Cl. G03C 1/492

(52) U.S. Cl. 430/270.1

(57) ABSTRACT

Disclosed is a support for a lithographic printing plate which, when measured over a 400 μm×400 μm surface region thereon using a three-dimensional non-contact roughness tester, has at most 5.0 convex portions of a height from centerline of at least 0.70 μm and an equivalent circle diameter of at least 20 μm, and has at least 800 concave portions of a depth from centerline of at least 0.50 μm and an equivalent circle diameter of at least 2.0 μm. Presensitized plates which are obtainable by using the support for a lithographic printing plate according to the present invention have an excellent scumming resistance and an extremely long press life.

The entire contents of literature cited in this specification are incorporated by reference.

### BACKGROUND OF THE INVENTION

The present invention relates to a support for a lithographic printing plate and a presensitized plate.

Lithographic printing is a process that makes use of the inherent immiscibility of water and oil. Lithographic printing plates used in lithographic printing have formed on a surface thereof regions which are receptive to water and repel oil-based inks (referred to below as “non-image areas”) and regions which repel water and are receptive to oil-based inks (referred to below as “image areas”).

The aluminum support employed in a lithographic printing plate (referred to below as a “support for lithographic printing plate”) is used in such a way as to carry non-image areas on its surface. It must therefore have a number of conflicting properties, including, on the one hand, an excellent hydrophilicity and water retention and, on the other hand, an excellent adhesion with the image recording layer that is provided thereon. For example, a trade-off generally exists between the scumming resistance of a printing plate and the press life of the plate, making it difficult to achieve a printing plate endowed with both a good scumming resistance and a long press life.

The approach generally taken for obtaining supports for lithographic printing plates in which all of these properties are achieved in good measure is to subject the surface of an aluminum sheet to graining treatment so as to impart a topography with convex and concave portions. Topographies in various shapes, as described below, have been proposed.

Some examples are a triple structure of large waves, medium waves and small waves in which the medium and small waves each have specified opening diameters (JP 8-300844 A, the term “JP XX-XXXXXX A” as used herein means an “unexamined published Japanese patent application”); a double structure of large and small waves that includes small waves of a specified diameter (JP 11-99758 A and JP 11-208138 A); a technique for providing two types of concave portions (pits), and additionally providing very small bumps (JP 11-167207 A); a double structure with openings of specified diameters (JP 2023476 B, the term “JP XXXXXXX B” as used herein means a “Japanese patent”); a double structure wherein a factor a30 which indicates surface smoothness has been specified (JP 8-300843 A); and a structure of overlapping pits in which the ratio of the pit diameters has been specified and which is obtained by a plurality of electrochemical graining treatments (also referred to below as “electrolytic graining treatment”) (JP 10-35133 A).

Graining methods that are used include mechanical graining methods such as ball graining, brush graining, wire graining and blast graining, electrolytic graining techniques in which the aluminum sheet is subjected to electrolytic etching in an electrolyte that contains hydrochloric acid and/or nitric acid, and graining methods which involve a combination of mechanical graining and electrolytic graining (U.S. Pat. No. 4,476,006).

JP 2003-145957 A describes a support for a lithographic printing plate which is manufactured by subjecting an aluminum sheet to, at least, alkali etching treatment, electrochemical graining treatment in an aqueous solution of nitric acid, alkali etching treatment at a concentration of at least 0.05 g/m², and electrochemical graining treatment in an aqueous solution of hydrochloric acid in order, and the surface thereof has a surface area difference ratio, which is the difference between the true surface area determined using an atomic force microscope and the apparent surface area divided by the apparent surface area, of 10 to 90%; a surface area percentage where the slope as determined using an atomic force microscope is at least 30° of not more than 75%; and a calculated average roughness after extracting the 0.2 to 2 μm wavelength component from the measured cross-section profile obtainable by using an atomic force microscope of not more than 0.25 μm. This support for a lithographic printing plate is intended to provide an improved sensitivity, a better scumming resistance, and a longer press life.

### SUMMARY OF THE INVENTION

However, the above techniques were intensively studied by the inventors and has not been found capable of providing both an excellent scumming resistance and a very long press life.

It is therefore one object of the invention to provide a support for a lithographic printing plate which has both an excellent scumming resistance and a very long press life, and another object of the invention is to provide a presensitized plate which uses such a support.

In searching for techniques to improve the press life of presensitized plates used in lithographic printing, the inventors have found that when printing is carried out using a lithographic printing plate, as the number of impressions printed from the plate increases, the image recording layer undergoes wear, sometimes uncovering and exposing convex portions of the support where the image recording layer is relatively thin, and as a result, ink fails to adhere to such uncovered areas of the support, so that areas which should become image areas instead become white specks.

In addition, the inventors have found that as the number of impressions rises, the image recording layer sometimes peels away from the support, and ink will not adhere in areas where the image recording layer has peeled away and left the support uncovered and bare; areas that should be image areas instead become non-image areas.

The inventors have learned from analyzing these effects that even when the image recording layer wears down, leaving convex portions of the support bare, if an uncovered spot has a very small surface area, ink present on the image recording layer surrounding it will adhere to that area; even if ink does not adhere, a white speck perceptible to the eye will not form on impressions made from the plate. However, the inventors have found that if the number of convex portions of a significant height and size is large, when the image recording layer wears down, the support at such spots readily becomes exposed and it becomes increasingly difficult for ink to adhere in these places, and as a result, white specks tend to arise.

The inventors have also found that supports from which the image recording layer readily peels and which thus tend to become bare have few concave portions of a specific size and depth.

Furthermore, based on the above findings, the inventors have discovered that by setting the number of convex portions of a specific size and height and the number of concave portions of a specific size and depth on the support within specific and unprecedented ranges, there can be obtained supports for lithographic printing plates which are endowed with an excellent scumming resistance and also have a very long press life.

Accordingly, the invention provides the following a support for a lithographic printing plate, and presensitized plate.
(i) A support for a lithographic printing plate which, when measured over a 400 μm×400 μm surface region thereon using a three-dimensional non-contact roughness tester, has at most 5.0 convex portions of a height from centerline of at least 0.70 μm and an equivalent circle diameter of at least 20 μm, and has at least 800 concave portions of a depth from centerline of at least 0.50 μm and an equivalent circle diameter of at least 2.0 μm.
(ii) The support for a lithographic printing plate of (i) above which has a surface area ratio ΔS⁵⁰ defined by formula (1) below
   ΔS⁵⁰=(Sₓ⁵⁰−S₀⁵⁰)/S₀⁵⁰×100(%) (1),
   wherein Sₓ⁵⁰ is a true surface area of a 50 μm×50 μm surface region as determined by three-point approximation from three-dimensional data obtained by measurement with an atomic force microscope at 512×512 points over the surface region and S₀⁵⁰ is a geometrically measured surface area of the surface region, of 30 to 80%.
(iii) A presensitized plate, which comprises the support for a lithographic printing plate of (i) or (ii) above and an image recording layer thereon.

Presensitized plates according to the present invention which are obtainable by using the inventive supports for lithographic printing plates have an excellent scumming resistance and an extremely long press life.

### BRIEF DESCRIPTION OF THE DRAWINGS

FIG. 1 is a schematic side view of the brush graining step used in mechanical graining treatment during manufacture of the inventive support for a lithographic printing plate.

FIG. 2 is a graph showing an example of an alternating current waveform that may be used in electrochemical graining treatment during manufacture of the inventive support for a lithographic printing plate.

FIG. 3 is a side view showing an example of a radial cell such as may be used in electrochemical graining treatment with alternating current during manufacture of the inventive support for a lithographic printing plate.

FIG. 4 is a schematic of an anodizing apparatus such as may be used in anodizing treatment during manufacture of the inventive support for a lithographic printing plate.

### DESCRIPTION OF THE PREFERRED EMBODIMENTS

The present invention is described below in conjunction with the attached drawings.

Support For Lithographic Printing Plate

Surface Shape

The support for a lithographic printing plate (lithographic printing plate support) of the present invention, when measured over a 400 μm×400 μm surface region thereon using a three-dimensional non-contact roughness tester, has at most 5.0 convex portions of a height from centerline of at least 0.70 μm and an equivalent circle diameter of at least 20 μm, and has at least 800 concave portions of a depth from centerline of at least 0.50 μm and an equivalent circle diameter of at least 2.0 μm.

As is described later in the specification, because the inventive lithographic printing plate support has such a surface shape, it exhibits an excellent scumming resistance and also has an extremely long press life.

At up to 5.0 convex portions of a height from centerline of at least 0.70 μm and an equivalent circle diameter of at least 20 μm, as measured over a 400 μm×400 μm surface region using a three-dimensional non-contact roughness tester, even when the image recording layer on the printing plate has undergone wear from the printing of a large number of impressions, white specks do not readily form. The number of such convex portions having a height from centerline of at least 0.70 μm and an equivalent circle diameter of at least 20 μm, as measured within the above-indicated surface region, is preferably 1.0 or less.

Moreover, at 800 or more concave portions of a depth from centerline of at least 0.50 μm and an equivalent circle diameter of at least 2.0 μm, as measured over a 400 μm×400 μm surface region using a three-dimensional non-contact roughness tester, the resulting anchoring effect discourages the image recording layer from peeling off the printing plate even when a large number of impressions have been printed. The number of such concave portions having a depth from centerline of at least 0.50 μm and an equivalent circle diameter of at least 2.0 μm, as measured within the above-indicated surface region, is preferably at least 1,000.

Measurement using a three-dimensional non-contact roughness tester is typically carried out as follows.

Using a three-dimensional non-contact roughness tester (e.g., Micromap 520 manufactured by Ryoka Systems Inc.), a 400 μm×400 μm surface region on the support is non-contact scanned at a resolution of 0.01 μm to obtain three-dimensional data. Next, using software (such as SX Viewer, produced by Ryoka Systems Inc.), this three-dimensional data is converted to binary values and subjected to image analysis to determine the number of convex portions having a height from centerline of at least 0.70 μm and an equivalent circle diameter of at least 20 μm and the number of concave portions having a depth from centerline of at least 0.50 μm and an equivalent circle diameter of at least 2.0 μm. Measurement is carried out at a given number of places (e.g., five places) on a sample, and the average of the measurements on the sample is determined.

It is preferable for the lithographic printing plate support of the invention to have a surface area ratio ΔS⁵⁰, defined by formula (1) below
ΔS⁵⁰=(Sₓ⁵⁰−S₀⁵⁰)/S₀⁵⁰×100(%) (1)
of 30 to 80%. Here, Sₓ⁵⁰ is a true surface area of a 50 μm×50 μm surface region as determined by three-point approximation from three-dimensional data obtained by measurement with an atomic force microscope at 512×512 points over this surface region, and S₀⁵⁰ is the geometrically measured surface area of the same surface region.

Moreover, making the surface area ratio ΔS⁵⁰ larger increases the surface area of contact between the image recording layer and the support, enabling an extremely long press life to be achieved. In the present invention, ΔS⁵⁰ is preferably at least 30%, and more preferably at least 35%. If ΔS⁵⁰ is too large, the scumming resistance decreases. Therefore, ΔS⁵⁰ is preferably not more than 80%, and more preferably not more than 70%.

Measurement of the surface area ratio ΔS⁵⁰ is typically carried out as follows.

The surface shape of the support is measured with an atomic force microscope (e.g., SPA 300/SPI3800N, manufactured by Seiko Instruments Inc.) so as to obtain three-dimensional data. A square piece measuring 1 cm×1 cm is cut from the lithographic printing plate support and placed on a horizontal sample holder mounted on a piezo scanner. A cantilever is then approached to the surface of the sample. When the cantilever reaches the zone where interatomic forces are appreciable, it scans the surface of the sample in the XY direction, reading off the surface topography of the sample based on the piezo displacement in the Z direction. A piezo scanner capable of scanning 150 μm in the XY direction and 10 μm in the Z direction is used. A cantilever having a resonance frequency of 120 to 400 kHz and a spring constant of 12 to 90 N/m (e.g., SI-DF20, manufactured by Seiko Instruments Inc.) is used, with measurement being carried out in the dynamic force mode (DFM). The three-dimensional data obtained is approximated by a least-squares method to correct for slight inclination of the sample and create a reference plane.

Measurement involves obtaining values at 512 by 512 points over a 50 μm×50 μm surface region on the sample. The resolution is 0.1 μm in the XY direction, and 0.15 nm in the Z direction. The scan rate is set to 50 μm/s.

Using the three-dimensional data (f(x,y)) obtained as described above, sets of three mutually neighboring points are selected and the surface areas of the microtriangles formed by the sets of three points are summated, thereby giving the true surface area Sₓ⁵⁰. The surface area ratio ΔS⁵⁰ is then calculated from the resulting true surface area Sₓ⁵⁰ and the geometrically measured surface area S₀⁵⁰ using formula (1) above.

Surface Treatment

The lithographic printing plate support of the present invention is obtained by administering surface treatment to an aluminum sheet, described later in the specification, in such as way as to form the above-described shape on the surface of the sheet. The method of manufacturing the lithographic printing plate support of the present invention is not subject to any particular limitation, and generally consists of using a combination of the various types of surface treatments mentioned below to produce the above-described surface shape.

Illustrative, non-limiting examples of methods that may be used to form the above-described grained shape on the surface of the aluminum sheet include methods in which the aluminum sheet is subjected to, in order, mechanical graining, alkali etching, desmutting with an acid, and electrochemically graining using an electrolyte; methods in which the aluminum sheet is mechanically grained, alkali etched, desmutted with acid, and electrochemically grained using different electrolytes, these steps being carried out a plurality of times; methods in which the aluminum sheet is subjected to, in order, alkali etching, desmutting with an acid, and electrochemical graining using an electrolyte; and methods in which the aluminum sheet is alkali etched, desmutted with an acid, and electrochemically grained using an electrolyte, these steps being carried out a plurality of times. In these methods, alkali etching and desmutting with an acid may additionally be carried out after electrochemical graining.

Each of the surface treatment steps is described in detail below.

Mechanical Graining Treatment

Mechanical graining treatment is less expensive than electrochemical graining and can form a surface having a topography with convex and concave portions of an average wavelength of 5 to 100 μm. It is thus effective as a graining means.

Examples of mechanical graining treatments include wire brush graining in which the aluminum surface is scratched with metal wire, ball graining in which the aluminum surface is grained with abrasive balls and an abrasive compound, and the brush graining described in JP 6-135175 A and JP 50-40047 B (the term “JP XX-XXXXXX B” as used herein means an “examined Japanese patent publication”) in which the surface is grained with a nylon brush and an abrasive compound.

It is also possible to use a transfer roll method in which a surface having a topography is pressed against the aluminum sheet. Specific examples of such methods that may be employed include the methods described in JP 55-74898 A, JP 60-36195 A and JP 60-203496 A, the method described in JP 6-55871 A which is characterized by carrying out transfer a plurality of times, and the method described in JP 6-24168 A which is characterized in that the surface has elasticity.

Other methods that can be used include methods in which transfer is repeatedly carried out using a transfer roll in which very small surface convex and concave portions have been etched such as by electrodischarge machining, shot blasting, laser machining or plasma etching; and a method in which a textured surface (surface having convex and concave portions) coated with very small particles is placed against the aluminum sheet, pressure is repeatedly applied from above the textured surface a plurality of times, and a textured pattern corresponding to the average diameter of the particles is repeatedly transferred to the aluminum sheet. Known methods such as those described in JP 3-8635 A, JP 3-66404 A and JP 63-65017 A can be used to impart a fine texture to the transfer roll. Alternatively, angular convex and concave portions may be applied to the surface by cutting fine grooves in the roll surface from two directions such as with a dicing tool, a cutting tool or a laser. The resulting roll surface may be treated such as by carrying out a known etching treatment to round somewhat the angular convex and concave portions thus formed.

A process such as quenching or hard chromium plating may also be carried out to increase the surface hardness.

In addition, use can also be made of the mechanical graining treatments described in, for example, JP 61-162351 A and JP 63-104889 A.

In the practice of the present invention, any the various methods mentioned above may be used in combination while taking into account productivity and other factors. It is preferable for these mechanical graining treatments to be carried out prior to electrochemical graining treatment.

The brush graining process, which may be suitably used as the mechanical graining treatment, is described below in detail.

The brush graining process is generally carried out using a roller-type brush composed of a round cylinder on the surface of which are set numerous bristles, typically made of a plastic material such as Nylon (Trademark), propylene plastic or polyvinyl chloride, to rub one or both sides of the aluminum sheet while an abrasive-containing slurry is sprayed onto the rotating brush. A polishing roller provided on the surface with a polishing layer can be used instead of the above-described roller-type brush and slurry.

When a roller-type brush is used, the bristles on the brush have a flexural modulus of preferably 10,000 to 40,000 kg/cm², and more preferably 15,000 to 35,000 kg/cm², and a stiffness of preferably 500 gf or less, and more preferably 400 gf or less. The brush diameter is generally 0.2 to 0.9 mm. The bristle length can be suitably selected in accordance with the outside diameter of the roller brush and the cylinder diameter, but is generally from 10 to 100 mm.

A known abrasive may be used. Illustrative examples include pumice stone, silica sand, aluminum hydroxide, alumina powder, silicon carbide, silicon nitride, volcanic ash, carborundum, emery, and mixtures thereof. Of these, pumice stone and silica sand are preferred. Silica sand is especially preferred because it is harder than pumice stone and breaks less readily, and thus has an excellent graining efficiency.

To provide an excellent graining efficiency and reduce the pitch of the grained pattern, it is desirable for the abrasive to have an average particle size of preferably 3 to 50 μm, and more preferably 6 to 45 μm.

The abrasive is typically suspended in water and used as a slurry. In addition to the abrasive, the slurry may include also such additives as a thickener, a dispersant (e.g., a surfactant), and a preservative. The slurry has a specific gravity in a range of preferably 0.5 to 2.

An example of an apparatus suitable for mechanical graining is that described in JP 50-40047 B.

Next, a transfer roll process that may be suitably used for mechanical graining is described.

The transfer roll process is a method in which a topography with convex and concave portions is formed on an aluminum sheet of the type described subsequently in this specification by transfer using a transfer roll, such as in a final rolling step.

An especially preferred transfer roll process is one which involves cold rolling to bring the aluminum sheet to its final thickness, or finish cold rolling to finish the surface shape following such adjustment in the final sheet thickness, and also involves forming a pattern of convex and concave portions on the surface of the aluminum sheet by pressing the surface having convex and concave portions of a metal-rolling roll directly against the aluminum sheet. For example, preferred use can be made of the method described in JP 6-262203 A.

By using an aluminum sheet having a pattern of convex and. concave portions on the surface, the energy consumed in subsequent steps such as electrochemical graining can be reduced, in addition to which the amount of dampening water used on the printing press can be easily regulated.

It is especially desirable for transfer to be carried out in a conventional final cold rolling operation for aluminum sheet. Rolling for the sake of transfer can be carried out in one to three passes, each having a rolling reduction of preferably 2 to 10%.

In the practice of the present invention, a surface pattern-transfer roll suitable for transferring a pattern of convex and concave portions to the aluminum sheet may be obtained by a method that involves blowing alumina particles against the surface of the roll. Air blasting is especially preferred.

The air pressure in air blasting is preferably. 1 to 10 kgf/cm² (9.81×10⁴ to 9.81×10⁵ Pa), and more preferably 2 to 5 kgf/cm² (1.96×10⁵ to 4.90×10⁵ Pa).

The alumina particles generally have an average particle size of 50 to 150 μm, preferably 60 to 130 μm, and more preferably 70 to 90 μm.

Air blasting is carried out with preferably two to five blasts of air, and more preferably two blasts of air.

The blasting angle in air blasting is preferably 60 to 120°, and more preferably 80 to 100°, with respect to the surface being blasted (the roll surface).

After air blasting, but before the subsequently described plating treatment, it is desirable to polish the roll so as to lower the average surface roughness Ra of the roll 10 to 40% relative to the surface roughness after air blasting. Preferred methods of polishing include those involving the use of sandpaper, a grindstone or a buff.

No particular limitation is imposed on the material of which the transfer roll is made. For example, the transfer roll may be made of any material known to be used in rolling rolls.

In the practice of the present invention, the use of a steel roll is preferred. A steel roll manufactured by casting is especially preferred. Examples of preferred roll materials include those having a composition containing 0.07 to 6 wt % of carbon, 0.2 to 1 wt % of silicon, 0.15 to 1 wt % of manganese, up to 0.03 wt % of phosphorus, up to 0.03 wt % of sulfur, 2.5 to 12 wt % of chromium, 0.05 to 1.1 wt % of molybdenum, up to 0.5 wt % of copper and up to 0.5 wt % of vanadium, with the remainder being iron and inadvertent impurities.

Illustrative examples of forged steels that may generally be used in metal-rolling rolls include tool steels (SKD), high-speed tool steels (SKH), high-carbon chromium-type bearing steels (SUJ), and forged steels containing carbon, chromium, molybdenum and vanadium as alloying elements. To achieve a long roll life, high-chromium alloy cast iron containing about 10 to 20 wt % chromium may be used.

Of the above, it is preferable to use a roll manufactured by a casting process. In such a case, it is preferable for the roll to have a hardness Hs after quenching and tempering of 80 to 100. Tempering is preferably carried out as a low-temperature tempering operation.

The roll has a diameter of preferably 200 to 1,000 mm, and a face length of preferably 1,000 to 4,000 mm.

It is preferable for the transfer roll on which convex and concave portions have been formed by air blasting to be subsequently washed, then subjected to hardening treatment such as quenching and hard chromium plating. This enhances the wear resistance, extending the life of the roll.

The hardening treatment is most preferably hard chromium plating. The hard chromium plating may be an electroplating method carried out in a bath known to be used in industrial chromium plating processes, such as a CrO₃—SO₄ bath or a CrO₃—SO₄-fluoride bath.

The thickness of the chromium coating formed by hard chromium plating is preferably 3 to 15 μm, and more preferably 5 to 10 μm. Within this range, separation of the applied chromium coating from the boundary between the underlying roll surface material and the chromium coating is less likely to occur and a sufficient wear resistance enhancing effect can be achieved. The thickness of the hard chromium coating can be controlled by adjusting the plating treatment time.

The transfer roll process is preferred in that the above-described surface shape can be easily imparted to the aluminum sheet.

In the transfer roll process, the desired surface shape can be achieved by means of such factors as the shape of convex and concave portions on the roll surface (e.g., the pitch of the convex portions) and the rolling reduction in the rolling operation, in combination with other surface treatment.

Electrochemical Graining

Electrochemical graining (also referred to below as “electrolytic graining”) can be carried out with an electrolyte of the type employed in conventional electrochemical graining using an alternating current. In particular, the use of an electrolyte containing primarily hydrochloric acid or nitric acid enables a convex-and-concave structure characteristic of the present invention to be formed on the surface of the aluminum sheet.

In the practice of the present invention, electrolytic graining preferably involves carrying out, before and after a cathodic electrolysis treatment, a first and a second electrolytic treatments with an alternating waveform current in an acidic solution. In cathodic electrolysis treatment, hydrogen gas evolves and smut forms at the surface of the aluminum sheet, thereby rendering the surface state uniform. This in turn enables uniform electrolytic graining to be achieved during subsequent electrolytic treatment with an alternating waveform current.

This electrolytic graining treatment may be carried out in accordance with, for example, the electrochemical graining processes (electrolytic graining processes) described in JP 48-28123 B and GB 896,563 B. These electrolytic graining processes use an alternating current having a sinusoidal waveform, although they may also be carried out using special waveforms like those described in JP 52-58602 A. Use can also be made of the waveforms described in JP 3-79799 A. Other methods that may be employed for this purpose include those described in JP 55-158298 A, JP 56-28898 A, JP 52-58602 A, JP 52-152302 A, JP 54-85802 A, JP 60-190392 A, JP 58-120531 A, JP 63-176187 A, JP 1-5889 A, JP 1-280590 A, JP 1-118489 A, JP 1-148592 A, JP 1-178496 A, JP 1-188315 A, JP 1-154797 A, JP 2-235794 A, JP 3-260100 A, JP 3-253600 A, JP 4-72079 A, JP 4-72098 A, JP 3-267400 A and JP 1-141094 A. In addition to the above, electrolytic treatment can also be carried out using alternating currents of special frequency such as have been proposed in connection with methods for manufacturing electrolytic capacitors. These are described in, for example, U.S. Pat. No. 4,276,129 and U.S. Pat. No. 4,676,879.

Various electrolytic cells and power supplies have been proposed for use in electrolytic treatment. For example, use may be made of those described in US 4,203,637, JP 56-123400 A, JP 57-59770 A, JP 53-12738 A, JP 53-32821 A, JP 53-32822 A, JP 53-32823 A, JP 55-122896 A, JP 55-132884 A, JP 62-127500 A, JP 1-52100 A, JP 1-52098 A, JP 60-67700 A, JP 1-230800 A, JP 3-257199 A, JP 52-58602 A, JP 52-152302 A, JP 53-12738 A, JP 53-12739 A, JP 53-32821 A, JP 53-32822 A, JP 53-32833 A, JP 53-32824 A, JP 53-32825, JP 54-85802 A, JP 55-122896 A, JP 55-132884 A, JP 48-28123 B, JP 51-7081 B, JP 52-133838 A, JP 52-133840 A, JP 52-133844 A, JP 52-133845 A, JP 53-149135 A and JP 54-146234 A.

In addition to nitric acid and hydrochloric acid solutions, other acidic solutions that may be used as the electrolyte include the electrolytes mentioned in U.S. Pat. No. 4,671,859, U.S. Pat. No. 4,661,219, U.S. Pat. No. 4,618,405, U.S. Pat. No. 4,600,482, U.S. Pat. No. 4,566,960, U.S. Pat. No. 4,566,958, U.S. Pat. No. 4,566,959, U.S. Pat. No. 4,416,972, U.S. Pat. No. 4,374,710, U.S. Pat. No. 4,336,113 and U.S. Pat. No. 4,184,932.

The acidic solution has a concentration of preferably 0.5 to 2.5 wt %, although a concentration of 0.7 to 2.0 wt % is especially preferred for use in the desmutting treatment mentioned above. The electrolyte temperature is preferably 20 to 80° C., and more preferably 30 to 60° C.

The aqueous solution composed primarily of hydrochloric acid or nitric acid may be obtained by dissolving a nitrate ion-containing compound such as aluminum nitrate, sodium nitrate or ammonium nitrate or a chloride ion-containing compound such as aluminum chloride, sodium chloride or ammonium chloride to a concentration of from 1 g/L to saturation in a 1 to 100 g/L solution of hydrochloric acid or nitric acid in water. The aqueous solution composed primarily of hydrochloric acid or nitric may contain dissolved therein metals which are present in the aluminum alloy, such as iron, copper, manganese, nickel, titanium, magnesium and silicon. It is preferable to use a solution prepared by dissolving a compound such as aluminum chloride or aluminum nitrate to an aluminum ion concentration of 3 to 50 g/L in a 0.5 to 2 wt % solution of hydrochloric acid or nitric acid in water.

Moreover, by adding and using a compound capable of forming a complex with copper, uniform graining may be carried out even on an aluminum sheet having a high copper content. Compounds capable of forming a complex with copper include ammonia; amines obtainable by substituting the hydrogen atom on ammonia with a hydrocarbon (e.g., aliphatic, aromatic) group, such as methylamine, ethylamine, dimethylamine, diethylamine, trimethylamine, cyclohexylamine, triethanolamine, triisopropanolamine and ethylenediamine tetraacetate (EDTA); and metal carbonates such as sodium carbonate, potassium carbonate and potassium hydrogencarbonate. Additional compounds suitable for this purpose include ammonium salts such as ammonium nitrate, ammonium chloride, ammonium sulfate, ammonium phosphate and ammonium carbonate.

The solution has a temperature of preferably 10 to 60° C., and more preferably 20 to 50° C.

No particular limitation is imposed on the AC power supply waveform used in electrochemical graining treatment. For example, sinusoidal, square, trapezoidal or triangular waveforms may be used. Of these, square or trapezoidal waveform is preferred, and a trapezoidal waveform is especially preferred. “Trapezoidal waveform” refers herein to a waveform like that shown in FIG. 2. In this trapezoidal waveform, it is preferable for the time until the current reaches a peak value from zero, or time-to-peak (TP), to be from 1 to 3 msec. At a TP of less than 1 msec, uneven treatment in the form of chatter marks perpendicular to the direction of movement by the aluminum sheet tend to arise. At a TP of more than 3 msec, particularly when a nitric acid-containing electrolyte is used, the process tends to be affected by trace ingredients in the electrolyte, such as ammonium ions, that spontaneously increase during electrolytic treatment, making it difficult to carry out uniform graining. As a result, lithographic printing plates obtained from such aluminum sheets tend to have a diminished scumming resistance.

Alternating current having a trapezoidal waveform and a duty ratio of 1:2 to 2:1 may be used. However, as noted in JP 5-195300 A, in an indirect power feed system that does not use a conductor roll to feed current to the aluminum, a duty ratio of 1:1 is preferred.

Alternating current having a trapezoidal waveform and a frequency of 0.1 to 120 Hz may be used, although a frequency of 50 to 70 Hz is preferable from the standpoint of the equipment. At a frequency lower than 50 Hz, the carbon electrode serving as the main electrode tends to dissolve more readily. On the other hand, at a frequency higher than 70 Hz, the power supply circuit is more readily subject to the influence of inductance thereon. The result in both of these cases is an increase in the power supply costs.

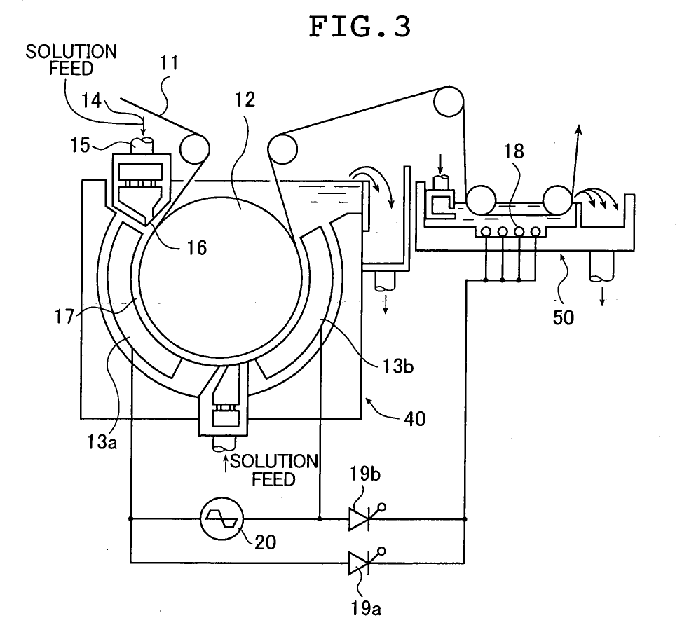

One or more AC power supply may be connected to the electrolytic cell. To control the anode/cathode current ratio of the alternating current applied to the aluminum sheet opposite the main electrodes and thereby carry out uniform graining and to dissolve carbon from the main electrodes, it is advantageous to provide an auxiliary anode and divert some of the alternating current as shown in FIG. 3. FIG. 3 shows a aluminum sheet 11, a radial drum roller 12, main electrodes 13a and 13b, an electrolytic treatment solution 14, an electrolyte feed inlet 15, a slit 16, an electrolyte channel 17, an auxiliary anode 18, thyristors 19a and 19b, an AC power supply 20, a main electrolytic cell 40, and an auxiliary anode cell 50. By using a rectifying or switching device to divert some of the current value as direct current to an auxiliary anode provided in a separate cell from that containing the two main electrodes, the ratio between the current value furnished to the anode reaction which acts on the aluminum sheet opposite the main electrodes and the current value furnished to the cathode reaction can be controlled. The ratio between the amount of electricity furnished to the cathode reaction and the amount of electricity furnished to the anode reaction (amount of electricity for cathode reaction/amount of electricity for anode reaction) on the aluminum sheet opposite the main electrodes is preferably from 0.3 to 0.95.

Any known electrolytic cell employed for surface treatment, including vertical, flat and radial type electrolytic cells, may be used, although radial-type electrolytic cells such as those described in JP 5-195300 A are especially preferred. The electrolyte is passed through the electrolytic cell either parallel or counter to the direction in which the aluminum web advances through the process.

aNitric Acid electrolysis:

Pits having an average diameter of 0.5 to 5 μm can be formed by electrochemical graining using an electrolyte composed primarily of nitric acid. When the amount of electricity is made relatively large, the electrolytic reaction concentrates, resulting also in the formation of honeycombed pits larger than 5 μm.

To obtain such a grain, the total amount of electricity furnished to the anode reaction on the aluminum sheet up until completion of the electrolytic reaction is preferably 1 to 1,000 C/dm², and more preferably 50 to 300 C/dm². The current density at this time is preferably 20 to 100 A/dm².

When a high-concentration or high-temperature nitric acid electrolyte is used, a small-wave structure having an average opening diameter of 0.2 μm or less can be formed.

Hydrochloric Acid Electrolysis:

Hydrochloric acid by itself has a strong ability to dissolve aluminum, and so very small convex and concave portions can be formed on the surface with the application of just a slight degree of electrolysis. These convex and concave portions have openings of an average diameter of 0.01 to 0.2 μm, and arise uniformly over the entire surface of the aluminum sheet. To obtain such a graining on the surface of the aluminum sheet, the total amount of electricity furnished to the anode reaction on the aluminum sheet up until completion of the electrolytic reaction is preferably 1 to 100 C/dm², and more preferably 20 to 70 C/dm². The current density at this time is preferably 20 to 50 A/dm².

In such electrochemical graining treatment with an electrolyte composed primarily of hydrochloric acid, by furnishing a large total amount of electricity of 400 to 1,000 C/dm² to the anode reaction, large crater-like undulations can also be formed at the same time. Under these conditions, very small convex and concave portions having openings of an average diameter of 0.01 to 0.4 μm will form over the entire surface in a manner superimposed on crater-like undulations having an average diameter of 10 to 30 μm.

In the practice of the present invention, it is preferable to carry out the above-described electrolytic graining treatment using an electrolyte composed primarily of nitric acid (nitric acid electrolysis) as the first electrolytic graining treatment, and to carry out the above-described electrolytic graining treatment using an electrolyte composed primarily of hydrochloric acid (hydrochloric acid electrolysis) as the second electrolytic graining treatment. That is, this invention provides a method of manufacturing supports for lithographic printing plates in which a support is obtained by subjecting an aluminum sheet to graining treatment which includes the successive administration of at least nitric acid electrolysis and hydrochloric acid electrolysis, and also administering anodizing treatment.

Between the first and second electrolytic graining treatments carried out in electrolytes composed of nitric acid, hydrochloric acid or the like, it is preferable to subject the aluminum sheet to cathodic electrolysis. Such treatment causes smut formation and hydrogen gas evolution to occur at the surface of the aluminum sheet, thereby enabling uniform electrolytic graining to be achieved. Cathodic electrolysis is carried out in an acidic solution at an amount of electricity applied to the cathode of preferably 3 to 80 C/dm², and more preferably 5 to 30 C/dm². At less than 3 C/dm² of electricity, smut deposition may be inadequate, whereas at more than 80 C/dm², smut deposition may be excessive. Neither condition is desirable. The electrolyte may be the same as or different from the solutions used in the first and second electrolytic graining treatments.

Alkali Etching Treatment

Alkali etching is treatment in which the surface layer of the above-described aluminum sheet is brought into contact with an alkali solution and dissolved.

When mechanical graining treatment has not been carried out, the purpose of carrying out alkali etching treatment prior to electrolytic graining treatment is to remove substances such as rolling oils, contaminants and a natural oxide film from the surface of the aluminum sheet (rolled aluminum). When mechanical graining treatment has already been carried out, the purpose of such alkali etching treatment is to dissolve edge areas of the surface convex and concave portions formed by mechanical graining treatment so as to transform abrupt convex and concave portions into a smoothly undulating surface.

If mechanical graining treatment is not carried out prior to alkali etching treatment, the amount of etching is preferably 0.1 to 10 g/m², and more preferably 1 to 5 g/m². At less than 0.1 g/m², substances such as rolling oils, contaminants and a natural oxide film may remain on the surface, which may make it impossible for uniform pits to form in subsequent electrolytic graining treatment, and may thus give rise to surface irregularities. On the other hand, at an etching amount of 1 to 10 g/m², the sufficient removal of substances such as rolling oils, contaminants and a natural oxide film will take place. An etching amount which exceeds the above range is economically undesirable.

If mechanical graining treatment is carried out prior to alkali etching treatment, the amount of etching is preferably 3 to 20 g/m², and more preferably 5 to 15 g/m². At an etching amount of less than 3 g/m², it may not be possible to smoothen the surface convex and concave portions formed by treatment such as mechanical graining treatment, as a result of which uniform pit formation may be impossible to achieve in subsequent electrolytic treatment. Moreover, contamination during printing may worsen. On the other hand, at an etching amount of more than 20 g/m², the surface structure of convex and concave portions may vanish.

The purpose of carrying out alkali etching treatment immediately after electrolytic graining treatment is to dissolve smut that has formed in the acidic electrolyte and to dissolve the edge areas of pits that have been formed by electrolytic graining treatment.

The pits that are formed by electrolytic graining treatment vary depending on the type of electrolyte, and so the optimal amount of etching also varies. However, the amount of etching in alkali etching treatment carried out after electrolytic graining treatment is preferably 0.1 to 5 g/m². When a nitric acid electrolyte is used, it is necessary to set the amount of etching somewhat higher than when a hydrochloric acid electrolyte is used.

If electrolyte graining treatment is carried out a plurality of times, alkali etching may be carried out as needed after each such treatment.

Alkalis that may be used in the alkali solution are exemplified by caustic alkalis and alkali metal salts. Specific examples of suitable caustic alkalis include sodium hydroxide and potassium hydroxide. Specific examples of suitable alkali metal salts include alkali metal silicates such as sodium metasilicate, sodium silicate, potassium metasilicate and potassium silicate; alkali metal carbonates such as sodium carbonate and potassium carbonate; alkali metal aluminates such as sodium aluminate and potassium aluminate; alkali metal aldonates such as sodium gluconate and potassium gluconate; and alkali metal hydrogenphosphates such as sodium hydrogenphosphate, potassium hydrogenphosphate, sodium phosphate and potassium phosphate. Of these, caustic alkali solutions and solutions containing both a caustic alkali and an alkali metal aluminate are preferred on account of the high etch rate and low cost. An aqueous solution of sodium hydroxide is especially preferred.

The concentration of the alkali solution may be set in accordance with the desired amount of etching, and is preferably 1 to 50 wt %, and more preferably 10 to 35 wt %. When aluminum ions are dissolved within the alkali solution, the concentration of the aluminum ions is preferably 0.01 to 10 wt %, and more preferably 3 to 8 wt %. It is preferable for the alkali solution to have a temperature of 20 to 90° C., and for the treatment time to be from 1 to 120 seconds.

Illustrative examples of methods for bringing the aluminum sheet into contact with the alkali solution include passing the aluminum sheet through a tank filled with an alkali solution, immersing the aluminum sheet in a tank filled with an alkali solution, and spraying the surface of the aluminum sheet with an alkali solution.

Desmutting Treatment

After electrolytic graining treatment or alkali etching treatment, it is preferable to carry out acid pickling (desmutting treatment) to remove contaminants (smut) remaining on the surface of the aluminum sheet. Examples of acids that may be used include nitric acid, sulfuric acid, phosphoric acid, chromic acid, hydrofluoric acid and tetrafluoroboric acid.

The above desmutting treatment may be carried out by bringing the aluminum sheet into contact with an acidic solution which has a 0.5 to 30 wt % concentration of acid such as hydrochloric acid, nitric acid or sulfuric acid, and contains 0.01 to 5 wt % of aluminum ions. Exemplary methods for bringing the aluminum sheet into contact with the acidic solution include passing the aluminum sheet through a tank filled with the acidic solution, immersing the aluminum sheet in a tank filled with the acidic solution, and spraying the acidic solution onto the surface of the aluminum sheet.

The acidic solution used in desmutting treatment may be the aqueous solution composed primarily of nitric acid or the aqueous solution composed primarily of hydrochloric acid that is discharged as wastewater from the above-described electrolytic graining treatment, or the aqueous solution composed primarily of sulfuric acid that is discharged as wastewater from the subsequently described anodizing treatment.

The solution temperature in desmutting treatment is preferably 25 to 90° C., and the treatment time is preferably 1 to 180 seconds. The acidic solution used in desmutting treatment may include therein dissolved aluminum and aluminum alloy components.

Anodizing Treatment

The aluminum sheet treated as described above is also administered anodizing treatment. Anodizing treatment can be carried out by any suitable method used in the field to which the invention relates. More specifically, an anodized layer can be formed on the surface of the aluminum sheet by passing a current through the aluminum sheet as the anode in, for example, a solution having a sulfuric acid concentration of 50 to 300 g/L and an aluminum concentration of up to 5 wt %. The solution used for anodizing treatment includes any one or combination of, for example, sulfuric acid, phosphoric acid, chromic acid, oxalic acid, sulfamic acid, benzenesulfonic acid and amidosulfonic acid.

It is acceptable for ingredients ordinarily present in at least the aluminum sheet, electrodes, tap water, ground water and the like to be present in the electrolyte solution. In addition, secondary and tertiary ingredients may be added. Here, “second and tertiary ingredients” includes, for example, the ions of metals such as sodium, potassium, magnesium, lithium, calcium, titanium, aluminum, vanadium, chromium, manganese, iron, cobalt, nickel, copper and zinc; cations such as ammonium ions; and anions such as nitrate ions, carbonate ions, chloride ions, phosphate ions, fluoride ions, sulfite ions, titanate ions, silicate ions and borate ions. These may be present in a concentration of about 0 to 10,000 ppm.

The anodizing treatment conditions vary empirically according to the electrolyte solution used, although it is generally suitable for the solution to have an electrolyte concentration of 1 to 80 wt % and a temperature of 5 to 70° C., and for the current density to be 0.5 to 60 A/dm², the voltage to be 1 to 100 V, and the electrolysis time to be 15 seconds to 50 minutes. These conditions may be adjusted to obtain the desired anodized layer weight.

Methods that may be used to carry out anodizing treatment include those described in JP 54-81133 A, JP 57-47894 A, JP 57-51289 A, JP 57-51290 A, JP 57-54300 A, JP 57-136596 A, JP 58-107498 A, JP 60-200256 A, JP 62-136596 A, JP 63-176494 A, JP 4-176897 A, JP 4-280997 A, JP 6-207299 A, JP 5-24377 A, JP 5-32083 A, JP 5-125597 A and JP 5-195291 A

Of these, as described in JP 54-12853 A and JP 48-45303 A, it is preferable to use a sulfuric acid solution as the electrolyte solution. The electrolyte solution has a sulfuric acid concentration of preferably 10 to 300 g/L (1 to 30 wt %), and has an aluminum ion concentration of preferably 1 to 25 g/L (0.1 to 2.5 wt %), and more preferably 2 to 10 g/L (0.2 to 1 wt %). An electrolyte solution of this type can be prepared by adding a compound such as aluminum sulfate to dilute sulfuric acid having a sulfuric acid concentration of 50 to 200 g/L.

When anodizing treatment is carried out in an electrolyte solution containing sulfuric acid, a direct current or an alternating current may be applied across the aluminum sheet and the counterelectrode.

When a direct current is applied to the aluminum sheet, the current density is preferably 1 to 60 A/dm², and more preferably 5 to 40 A/dm².

To keep so-called “burnt” deposits from arising on portions of the aluminum sheet due to the concentration of current when anodizing treatment is carried out as a continuous process, it is preferable to apply current at a low density of 5 to 10 A/m² at the start of anodizing treatment and to increase the current density to 30 to 50 A/dm² or more as anodizing treatment proceeds.

When anodizing treatment is carried out as a continuous process, this is preferably done using a system that supplies power to the aluminum sheet through the electrolyte solution.

By carrying out anodizing treatment under such conditions, a porous film having numerous micropores can be obtained. These micropores generally have an average diameter of about 5 to 50 nm and an average pore density of about 300 to 800 pores/μm².

The weight of the anodized layer is preferably 1 to 5 g/m². At less than 1 g/m², the printing plate tends to mar easily. On the other hand, a weight of more than 5 g/m² requires the use of a large amount of electrical power, which is economically disadvantageous. An anodized layer weight of 1.5 to 4 g/m² is more preferred. It is also desirable for anodizing treatment to be carried out in such a way that the difference in the weight of the anodized layer between the center of the aluminum sheet and areas near the edges of the sheet is not more than 1 g/m².

Examples of electrolyzing apparatuses that may be used in anodizing treatment include those described in JP 48-26638 A, JP 47-18739 A and JP 58-24517 B.

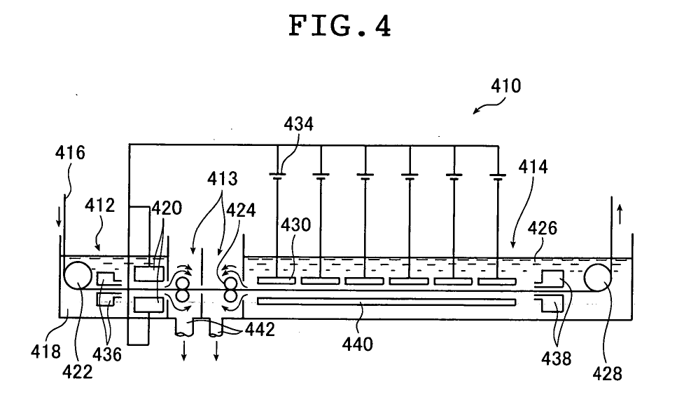

Of these, an apparatus like that shown in FIG. 4 is preferred. FIG. 4 is a schematic of an apparatus that may be used to anodize the surface of the aluminum sheet. In the anodizing apparatus 410 shown in FIG. 4, an aluminum sheet 416 is conveyed as indicated by the arrows in the diagram. In a power supplying tank 412 filled with an electrolyte solution 418, a positive charge is applied to the aluminum sheet 416 by power supplying electrodes 420. The aluminum sheet 416 then moves upward under the action of a path roller 422 in the power supplying tank 412, after which nip rollers 424 cause it to change direction and move downward. The aluminum sheet 416 is subsequently carried toward an electrolytic treatment tank 414 filled with an electrolytic solution 426, where it changes to a horizontal direction under the action of another path roller 428. A negative charge is then applied to the aluminum sheet 416 by electrolyzing electrodes 430 so as to form an anodized layer on the surface thereof, after which the aluminum sheet 416 exits the electrolytic treatment tank 414 and moves on to the next operation. In the anodizing apparatus 410, the path rollers 422 and 428 and the nip rollers 424 function together as direction changing means which convey the aluminum sheet 416 between the power supplying tank 412 and the electrolytic treatment tank 414 along an inverted V-shaped path and an inverted U-shaped path. The power supplying electrodes 420 and electrolyzing electrodes 430 are connected to DC power supplies 434.

The anodizing treatment apparatus 410 shown in FIG. 4 is characterized in that the power supply tank 412 and the electrolyzing treatment tank 414 are separated by walls 432, and in that the aluminum sheet 416 moves between the tanks along an inverted V-shaped path and an U-shaped path. This enables the length of the aluminum sheet 416 between the tanks to be minimized. As a result, the overall length of the anodizing treatment apparatus 410 can be shortened, allowing the equipment costs to be reduced. Moreover, moving the aluminum sheet 416 along an inverted V-shaped path and an inverted U-shaped path eliminates the need to form openings in the walls 432 of the respective tanks 412 and 414 to allow passage of the aluminum sheet 416. In turn, the amount of fresh solution needed to replenish and maintain the liquid in the respective tanks 412 and 414 at the required levels can be reduced, thus making it possible to hold down the operating costs.

Sealing Treatment

In the practice of the present invention, if necessary, sealing treatment may be carried out to close the micropores present in the anodized layer. Sealing treatment may be carried out in accordance with a known method, such as boiling water treatment, hot water treatment, steam treatment, sodium silicate treatment, nitrite treatment and ammonium acetate treatment. For example, sealing treatment may be carried out using the apparatuses and methods described in JP 56-12518 B, JP 4-4194 A, Japanese Patent Application No. 4-33952 (JP 5-202496 A) and Japanese Patent Application No. 4-33951 (JP 5-179482 A).

Of these, it is preferable to carry out sealing treatment using an aqueous solution containing a fluorine compound and a phosphate compound.

Preferred fluorine compounds include metal fluorides such as sodium fluoride, potassium fluoride, calcium fluoride, magnesium fluoride, sodium hexafluorozirconate, potassium hexafluorozirconate, sodium hexafluorotitanate, potassium hexafluorotitanate, ammonium hexafluorozirconate, ammonium hexafluorotitanate, hexafluorozirconic acid, hexafluorotitanic acid, hexafluorosilicic acid, nickel fluoride, iron fluoride, hexafluorophosphoric acid and ammonium hexafluorophosphate. Of these, sodium hexafluorozirconate, sodium hexafluorotitanate, hexafluorozirconic acid and hexafluorotitanic acid are preferred.

Preferred phosphates include the phosphoric acid salts of metals such as alkali metals and alkaline earth metals, some specific examples of which are zinc phosphate, aluminum phosphate, ammonium phosphate, ammonium hydrogenphosphate, ammonium dihydrogenphosphate, potassium dihydrogenphosphate, sodium dihydrogenphosphate, dipotassium hydrogenphosphate, tribasic calcium phosphate, ammonium sodium hydrogenphosphate, magnesium hydrogenphosphate, magnesium phosphate, iron (II) phosphate, iron (III) phosphate, sodium phosphate, sodium hydrogenphosphate, lead phosphate, dibasic calcium phosphate, lithium phosphate, phosphotungstic acid, ammonium phosphotungstate, sodium phosphotungstate, ammonium phosphomolybdate, sodium phosphomolybdate, sodium phosphite, sodium tripolyphosphate and sodium pyrophosphate. Of these, sodium dihydrogenphosphate, sodium hydrogenphosphate, potassium dihydrogenphosphate and potassium hydrogenphosphate are preferred.

Combinations of the fluorine compound and the phosphate compounds are not subject to any particular limitation, although it is preferable for the fluorine compound to be sodium hexafluorozirconate and for the phosphate compound to be sodium dihydrogenphosphate.

The aqueous solution has a fluorine compound concentration of preferably at least 290 mg/L, and more preferably at least 460 mg/L, but preferably not more than 2,200 mg/L, and more preferably not more than 1,400 mg/L.

The aqueous solution has a phosphate compound concentration of preferably at least 1.0 g/L, and more preferably at least 1.5 g/L, but preferably not more than 10.0 g/L, and more preferably not more than 4.0 g/L.

Although no particular limitation is imposed on the ratio of the respective compounds in the aqueous solution, the weight ratio between the fluorine compound and the phosphate compound is preferably from 1/200 to 10/1, and more preferably from 1/30 to 2/1.

The aqueous solution has a temperature of preferably at least 40° C., and more preferably at least 60° C., but preferably not more than 95° C., and more preferably not more than 80° C.

Moreover, the aqueous solution has a pH of preferably at least 3.0, and more preferably at least 3.2, but preferably not more than 5.0, and more preferably not more than 3.8.

The method of preparing the aqueous solution is not subject to any particular limitation. For example, the solution can be obtained by dissolving the fluorine compound and the phosphate compound in water. In this case, the fluorine compound and the phosphate compound may be dissolved in water at the same time or one after the other. Alternatively, the fluorine compound and/or the phosphate compound may be individually dissolved in water, then the two components mixed.

If the phosphate compound and the fluorine compound are used as powders, to promote dissociation of the fluorine compound, it is preferable for the fluorine compound to be the first dissolved in water.

Any suitable method such as dipping or spraying may be used to carry out sealing treatment with a fluorine compound-containing aqueous solution. Any one such method may be used once or a plurality of times, or a combination of two or more such methods may be used.

Hydrophilizing Treatment

In the practice of the present invention, it is advantageous to carry out hydrophilizing treatment after sealing treatment. Illustrative examples of suitable hydrophilizing treatments include the phosphomolybdate treatment described in U.S. Pat. No. 3,201,247, the alkyl titanate treatment described in GB 1,108,559 B, the polyacrylic acid treatment described in DE 1,091,433 B, the polyvinylphosphonic acid treatments described in DE 1,134,093 B and GB 1,230,447 B, the phosphonic acid treatment described in JP 44-6409 B, the phytic acid treatment described in U.S. Pat. No. 3,307,951, the treatments involving the divalent metal salts of lipophilic organic polymeric compounds described in JP 58-16893 A and JP 58-18291 A, treatments like that described in U.S. Pat. No. 3,860,426 in which an aqueous metal salt (e.g., zinc acetate)-containing hydrophilic cellulose (e.g., carboxymethyl cellulose) undercoat is provided, and a treatment like that described in JP 59-101651 A in which a sulfo group-bearing water-soluble polymer is undercoated.

Additional examples of suitable hydrophilizing treatments include undercoating treatment using the phosphates mentioned in JP 62-19494 A, the water-soluble epoxy compounds mentioned in JP 62-33692 A, the phosphoric acid-modified starches mentioned in JP 62-97892 A, the diamine compounds mentioned in JP 63-56498 A, the inorganic or organic salts of amino acids mentioned in JP 63-130391 A, the carboxyl or hydroxyl group-bearing organic phosphonic acids mentioned in JP 63-145092 A, the amino group and phosphonate group-containing compounds mentioned in JP 63-165183 A, the specific carboxylic acid derivatives mentioned in JP 2-316290 A, the phosphate esters mentioned in JP 3-215095 A, the compounds having one amino group and one phosphorus oxo acid group mentioned in JP 3-261592 A, the phosphate esters mentioned in JP 3-215095 A, the aliphatic or aromatic phosphonic acids (e.g., phenylphosphonic acid) mentioned in JP 5-246171 A, the sulfur atom-containing compounds (e.g., thiosalicylic acid) mentioned in JP 1-307745 A, and the phosphorus oxo acid group-bearing compounds mentioned in JP 4-282637 A.

Coloration with an acid dye as mentioned in JP 60-64352 A may also be carried out.

It is preferable to carry out hydrophilizing treatment by a method in which the aluminum sheet is immersed in an aqueous solution of an alkali metal silicate such as sodium silicate or potassium silicate, or is coated with a hydrophilic vinyl polymer or some other hydrophilic compound so as to form a hydrophilic undercoat.

Hydrophilizing treatment with an aqueous solution of an alkali metal silicate such as sodium silicate or potassium silicate can be carried out according to the processes and procedures described in U.S. Pat. No. 2,714,066 and U.S. Pat. No. 3,181,461.

Illustrative examples of suitable alkali metal silicates include sodium silicate, potassium silicate and lithium silicate. The aqueous solution of an alkali metal silicate may include a suitable amount of, for example, sodium hydroxide, potassium hydroxide or lithium hydroxide.

An alkaline earth metal salt or a Group 4 (Group IVA) metal salt may also be included in the aqueous solution of an alkali metal silicate. Examples of suitable alkaline earth metal salts include nitrates such as calcium nitrate, strontium nitrate, magnesium nitrate and barium nitrate; and also sulfates, hydrochlorides, phosphates, acetates, oxalates, and borates. Exemplary Group 4 (Group IVA) metal salts include titanium tetrachloride, titanium trichloride, titanium potassium fluoride, titanium potassium oxalate, titanium sulfate, titanium tetraiodide, zirconyl chloride, zirconium oxide and zirconium tetrachloride. These alkaline earth metal salts and Group 4 (Group IVA) metal salts may be used singly or in combinations of two or more thereof.

The amount of silicon adsorbed as a result of alkali metal silicate treatment can be measured with a fluorescent x-ray analyzer, and is preferably about 1.0 to 15.0 mg/m².

This alkali metal silicate treatment has the effect of enhancing the resistance at the surface of the support for a lithographic printing plate to dissolution by an alkali developer, suppressing the leaching of aluminum components into the developer, and reducing the evolution of development dusts owing to developer fatigue.

Hydrophilizing treatment involving the formation of a hydrophilic undercoat can also be carried out in accordance with the conditions and procedures described in JP 59-101651 A and JP 60-149491 A.

Hydrophilic vinyl polymers that may be used in such a method include copolymers of a sulfo group-bearing vinyl polymerizable compound such as polyvinylsulfonic acid or sulfo group-bearing p-styrenesulfonic acid with a conventional vinyl polymerizable compound such as an alkyl (meth)acrylate. Examples of hydrophilic compounds that may be used in this method include compounds having at least one group selected from among —NH₂ groups, —COOH groups and sulfo groups.

Rinsing Treatment

Following the completion of the above treatment steps, it is preferable to rinse the treated aluminum sheet with water. Rinsing can be carried out with, for example, purified water, well water or tap water. A nip roller unit may be used to prevent the drag-in of processing solution to the next process.

Aluminum Sheet (Rolled Aluminum)

A known aluminum sheet can be used to obtain the lithographic printing plate support of the present invention. The aluminum sheet used in the present invention is made of a dimensionally stable metal composed primarily of aluminum; that is, aluminum or aluminum alloy. Aside from sheets of pure aluminum, alloy sheets composed primarily of aluminum and containing small amounts of other elements can also be used.

In the present specification, the various above-described supports made of aluminum or aluminum alloy are referred to generically as “aluminum sheet.” Other elements which may be present in the aluminum alloy include silicon, iron, manganese, copper, magnesium, chromium, zinc, bismuth, nickel and titanium. The content of other elements in the alloy is not more than 10 wt %.

Aluminum sheets that are suitable for use in the present invention are not specified here as to composition, but include known materials that appear in the 4^{th} edition of Aluminum Handbook published in 1990 by the Japan Light Metal Association, such as aluminum-manganese-based aluminum sheets having the designations JIS A1050, JIS A1100, JIS A1070, the manganese-containing designation JIS A3004, and Internationally Alloy Designation 3103A. For increased tensile strength, it is preferable to use aluminum-magnesium alloys and aluminum-manganese-magnesium alloys (JIS A3005) composed of the above aluminum alloys to which at least 0.1 wt % of magnesium has been added. Aluminum-zirconium alloys and aluminum-silicon alloys which additionally contain zirconium or silicon may also be used. Use can also be made of aluminum-magnesium-silicon alloys.

The present applicant has disclosed related art concerning JIS 1050 materials in JP 59-153861 A, JP 61-51395 A, JP 62-146694 A, JP 60-215725 A, JP 60-215726 A, JP 60-215727 A, JP 60-216728 A, JP 61-272367 A, JP 58-11759 A, JP 58-42493 A, JP 58-221254 A, JP 62-148295 A, JP 4-254545 A, JP 4-165041 A, JP 3-68939 B, JP 3-234594 A, JP 1-47545 B and JP 62-140894 A. The art described in JP 1-35910 B and JP 55-28874 B is also known.

This applicant has also disclosed related art concerning JIS 1070 materials in JP 7-81264 A, JP 7-305133 A, JP 8-49034 A, JP 8-73974 A, JP 8-108659 A and JP 8-92679 A.

In addition, this applicant has disclosed related art concerning aluminum-magnesium alloys in JP 62-5080 B, JP 63-60823 B, JP 3-61753 B, JP 60-203496 A, JP 60-203497 A, JP 3-11635 B, JP 61-274993 A, JP 62-23794 A, JP 63-47347 A, JP 63-47348 A, JP 63-47349 A, JP 64-1293 A, JP 63-135294 A, JP 63-87288 A, JP 4-73392 B, JP 7-100844 B, JP 62-149856 A, JP 4-73394 B, JP 62-181191 A, JP 5-76530 B, JP 63-30294 A, JP 6-37116 B, JP 2-215599 A and JP 61-201747 A.

This applicant has disclosed related art concerning aluminum-manganese alloys in JP 60-230951 A, JP 1-306288 A, JP 2-293189 A, JP 54-42284 B, JP 4-19290 B, 4-19291 B, JP 4-19292 B, JP 61-35995 A, JP 64-51992 A, JP 4-226394 A, US 5,009,722 and U.S. Pat. No. 5,028,276.

The present applicant has disclosed related art concerning aluminum-manganese-magnesium alloys in JP 62-86143 A, JP 3-222796 A, JP 63-60824 B, JP 60-63346 A, JP 60-63347 A, JP 1-293350 A, EP 223,737 B, U.S. Pat. No. 4,818,300 and GB 1,222,777 B.

Also, this applicant has disclosed related art concerning aluminum-zirconium alloys in JP 63-15978 B, JP 61-51395 A, JP 63-143234 A and JP 63-143235 A.

This applicant has disclosed related art concerning aluminum-magnesium-silicon alloys in GB 1,421,710 B.

The aluminum alloy may be rendered into sheet stock by a method such as the following, for example. First, an aluminum alloy melt that has been adjusted to a given alloying ingredient content is subjected to cleaning treatment by an ordinary method, then is cast. Cleaning treatment, which is carried out to remove hydrogen and other unwanted gases from the melt, typically involves flux treatment; degassing treatment using argon gas, chlorine gas or the like; filtering treatment using, for example, what is referred to as a rigid media filter (e.g., ceramic tube filter, ceramic foam filter), a filter that employs a filter medium such as alumina flakes or alumina balls, or a glass cloth filter; or a combination of degassing treatment and filtering treatment.

Cleaning treatment is preferably carried out to prevent defects due to foreign matter such as nonmetallic inclusions and oxides in the melt, and defects due to dissolved gases in the melt. The filtration of melts is described in, for example, JP 6-57432 A, JP 3-162530 A, JP 5-140659 A, JP 4-231425 A, JP 4-276031 A, JP 5-311261 A, and JP 6-136466 A. The degassing of melts is described in, for example, JP 5-51659 A and JP 5-49148 A. The present applicant discloses related art concerning the degassing of melts in JP 7-40017 A.

Next, the melt that has been subjected to cleaning treatment as described above is cast. Casting methods include those which use a stationary mold, such as direct chill casting, and those which use a moving mold, such continuous casting.

In direct chill casting, the melt is solidified at a cooling speed of 0.5 to 30° C. per second. At less than 1° C./s, many coarse intermetallic compounds form. When direct chill casting is carried out, an ingot having a thickness of 300 to 800 mm can be obtained. If necessary, this ingot is scalped by a conventional method, generally removing 1 to 30 mm, and preferably 1 to 10 mm, of material from the surface. The ingot may also be optionally soaked, either before or after scalping. In cases where soaking is carried out, the ingot is heat treated at 450 to 620° C. for 1 to 48 hours to prevent the coarsening of intermetallic compounds. The effects of soaking treatment may be inadequate if heat treatment is shorter than one hour.

The ingot is then hot-rolled and cold-rolled, giving a rolled aluminum sheet. A temperature of 350 to 500° C. at the start of hot rolling is appropriate. Intermediate annealing may be carried out before or after hot rolling, or even during hot rolling. The intermediate annealing conditions may consist of 2 to 20 hours of heating at 280 to 600° C., and preferably 2 to 10 hours of heating at 350 to 500° C., in a batch-type annealing furnace, or of heating for up to 6 minutes at 400 to 600° C., and preferably up to 2 minutes at 450 to 550° C., in a continuous annealing furnace. Using a continuous annealing furnace to heat the rolled sheet at a temperature rise rate of 10 to 200° C./s enables a finer crystal structure to be achieved.

The aluminum sheet that has been finished by the above process to a given thickness of, say, 0.1 to 0.5 mm may then be passed through a leveling machine such as a roller leveler or a tension leveler to improve the flatness. The flatness may be improved in this way after the continuous aluminum sheet has been cut into discrete pieces. However, to enhance productivity, it is preferable to carry out such flattening with the rolled aluminum in the state of a continuous coil. The sheet may also be passed through a slitter line to cut it to a predetermined width. A thin film of oil may be provided on the aluminum sheet to prevent scuffing due to rubbing between adjoining aluminum sheets. Suitable use may be made of either a volatile or non-volatile oil film, as needed.

Continuous casting methods that are industrially carried out include methods which use cooling rolls, such as the twin roll method (Hunter method) and the 3C method; and methods which use a cooling belt or a cooling block, such as the twin belt method (Hazelett method) and the Alusuisse Caster II mold. When a continuous casting method is used, the melt is solidified at a cooling rate of 100 to 1,000° C./s. Continuous casting methods generally have a faster cooling rate than direct chill casting methods, and so are characterized by the ability to achieve a higher solid solubility by alloying ingredients in the aluminum matrix. Technology relating to continuous casting methods that has been disclosed by the present applicant is described in, for example, JP 3-79798 A, JP 5-201166 A, JP 5-156414 A, JP 6-262203 A, JP 6-122949 A, JP 6-210406 A and JP 6-26308 A.

When continuous casting is carried out, such as by a method involving the use of cooling rolls (e.g., the Hunter method), the melt can be directly and continuously cast as a sheet having a thickness of 1 to 10 mm, thus making it possible to omit the hot rolling step. Moreover, when use is made of a method that employs a cooling belt (e.g., the Hazelett method), a sheet having a thickness of 10 to 50 mm can be cast. Generally, by positioning a hot-rolling roll immediately after casting, the cast plate can then be successively rolled, making it possible to obtain a continuously cast and rolled sheet having a thickness of 1 to 10 mm.

These continuously cast and rolled plates are then passed through such steps as cold rolling, intermediate annealing, flattening and slitting in the same way as described above for direct chill casting, and thereby finished to a sheet thickness of typically 0.1 to 0.5 mm. Technology disclosed by the present applicant concerning the intermediate annealing conditions and cold rolling conditions in a continuous casting method is described in, for example, JP-A 6-220593 A, JP 6-210308 A, JP 7-54111 A and JP 8-92709 A.

It is desirable for the aluminum sheet manufactured as described above to have the following properties. For the aluminum sheet to provide the stiffness required of a lithographic printing plate support, it should have a 0.2% offset yield strength of preferably at least 140 MPa. To ensure some degree of stiffness even when burning treatment has been carried out, the 0.2% offset yield strength following 3 to 10 minutes of heat treatment at 270° C. should be at least 80 MPa, and preferably at least 100 MPa. In cases where the aluminum sheet is required to have a high stiffness, use may be made of an aluminum material containing also magnesium or manganese. However, because a higher stiffness lowers the ease with which the plate can be fit onto the plate cylinder of a printing press, the plate material and the amounts of minor components added thereto are suitably selected according to the intended application. Related technology disclosed by the present applicant is described in, for example, JP 7-126820 A and JP 62-140894 A.

Because the crystal structure at the surface of the aluminum sheet may give rise to a poor surface quality when chemical graining treatment or electrochemical graining treatment is carried out, it is preferable that the crystal structure not be too coarse. The crystal structure at the surface of the aluminum sheet has a width of preferably 200 μm or less, more preferably 100 μm or less, and most preferably 50 μm or less. Moreover, the crystal structure has a length of preferably 5,000 μm or less, more preferably 1,000 μm or less, and most preferably 500 μm or less. Related technology disclosed by the present applicant is described in, for example, JP 6-218495 A, JP 7-39906 A and JP 7-124609 A.

It is preferable for the alloying element distribution at the surface of the aluminum sheet to be reasonably uniform because non-uniform distribution of alloying ingredients at the surface of the aluminum sheet sometimes results in a poor surface quality when chemical graining treatment or electrochemical graining treatment has been carried out. Related technology disclosed by the present applicant is described in, for example, JP 6-48058 A, JP 5-301478 A and JP 7-132689 A.

The size and density of intermetallic compounds in the aluminum sheet may exert an effect on the chemical graining treatment or electrochemical graining treatment. Related technology disclosed by the present applicant is described in, for example, JP 7-138687 A and JP 4-254545 A.

In the practice of the present invention, an aluminum sheet like that described above can also be used after having formed thereon convex and concave portions, such as by multi-layer rolling or transfer, in a final rolling operation.

The aluminum sheet used in this invention is in the form of a continuous web or discrete pieces. That is, it may be either an belt-like sheet web or individual sheets cut to a size which corresponds to the presensitized plates that will be shipped as the final product.

Because scratches and other marks on the surface of the aluminum sheet may become defects when the sheet is fabricated into a lithographic printing plate support, it is essential to minimize the formation of such marks prior to the surface treatment operations for rendering the aluminum sheet into a lithographic printing plate support. It is thus desirable for the aluminum sheet to be stably packed in such a way that it will not be easily damaged during transport.

When the aluminum sheet is in the form of a web, it may be packed by, for example, laying hardboard and felt on an iron pallet, placing cardboard doughnuts on either side of the product and wrapping polytubing about everything, then inserting a wooden doughnut into the opening at the center of the coil, stuffing felt around the periphery of the coil, tightening steel strapping about the entire package, and labeling the exterior. In addition, polyethylene film can be used as an outer wrapping material, and needled felt and hardboard can be used as a cushioning material. Various other forms of packing exist, any of which may be used so long as the aluminum sheet can be stably transported without being scratched or otherwise marked.

The aluminum sheet used in the present invention has a thickness of preferably about 0.1 to 0.6 mm, more preferably 0.15 to 0.4 mm, and even more preferably 0.2 to 0.3 mm. This thickness may be changed as appropriate based on such considerations as the size of the printing press, the size of the printing plate and the desires of the user.

Back Coat

If necessary, the lithographic printing plate support obtainable as described above may be provided on the back side with a coat (referred to hereinafter also as the “back coat”) composed of an organic polymeric compound so that scuffing of the image recording layer does not occur even when presensitized plates produced from such supports are stacked on top of one another.

The back coat preferably contains as the main component at least one resin which has a glass transition point of at least 20° C. and is selected from the group consisting of saturated copolyester resins, phenoxy resins, polyvinyl acetal resins and vinylidene chloride copolymer resins.

The saturated copolyester resin used in the back coat is composed of dicarboxylic acid units and diol units. Examples of the dicarboxylic acid units include aromatic dicarboxylic acids such as phthalic acid, terephthalic acid, isophthalic acid, tetrabromophthalic acid and tetrachlorophthalic acid; and saturated aliphatic dicarboxylic acids such as adipic acid, azelaic acid, succinic acid, oxalic acid, suberic acid, sebacic acid, malonic acid and 1,4-cyclohexanedicarboxylic acid.

The back coat may additionally include dyes and pigments for coloration; any of the following to improve adhesion to the support: silane coupling agents, diazo resins composed of diazonium salts, organophosphonic acids, organophosphoric acids, cationic polymers; and the following substances which are commonly used as slip agents: waxes, higher aliphatic acids, higher aliphatic acid amides, silicone compounds composed of dimethylsiloxane, modified dimethylsiloxane, and polyethylene powder.

The back coat should have a thickness which is of a degree that will help protect the subsequently described recording layer from scuffing, even in the absence of a slip sheet. A thickness of 0.01 to 8 μm is preferred. At a thickness of less than 0.01 μm, it may be difficult to prevent scuffing of the recording layer when a plurality of presensitized plates are stacked and handled together. On the other hand, at a thickness of more than 8 μm, the chemicals used in the vicinity of the lithographic printing plate during printing cause the back coat to swell and change in thickness, which may alter the printing pressure and thereby compromise the printability.

Any of various methods may be used to provide the back coat on the back side of the support. Illustrative examples include dissolving the above-mentioned back coat-forming ingredients in a suitable solvent and applying the resulting solution, or preparing an emulsified dispersion from these ingredients and applying the dispersion, then drying. Another method that may be used is to first form a film, then laminate and bond the film to the support using an adhesive or heat. Yet another method involves using a melt extruder to form a molten film, then laminating the film onto the support. In another method, which is especially preferred for achieving a suitable thickness, the back coat-forming ingredients are dissolved in a suitable solvent and the resulting solution is applied to the support and dried. Organic solvents such as those mentioned in JP 62-251739 A may be used singly or in admixture as the medium in such methods.

During production of the presensitized plate, it is possible to first provide on the support either the back coat on the back side or the image recording layer on the front side. Alternatively, both may be provided at the same time.

Presensitized Plate

Image Recording Layer

The presensitized plate of the present invention can be obtained by providing an image recording layer on the inventive lithographic printing plate support. A photosensitive composition may be used in the image recording layer.

Preferred examples of photosensitive compositions that may be used in the present invention include, but are not particularly limited to, thermal positive-working photosensitive compositions containing an alkali-soluble polymeric compound and a photothermal conversion substance (such compositions and the image recording layers obtained using these compositions are referred to below as “thermal positive-type” compositions and image recording layers), thermal negative-working photosensitive compositions containing a curable compound and a photothermal conversion substance (these compositions and the image recording layers obtained therefrom are similarly referred to below as “thermal negative-type” compositions and image recording layers) photopolymerizable photosensitive compositions (referred to below as “photopolymer-type” compositions), negative-working photosensitive compositions containing a diazo resin or a photo-crosslinkable resin (referred to below as “conventional negative-type” compositions), positive-working photosensitive compositions containing a quinonediazide compound (referred to below as “conventional positive-type” compositions), and photosensitive compositions that do not require a special development step (referred to below as “non-treatment type” compositions).

Lithographic printing plate supports according to the present invention, when made with a photosensitive composition and image recording layer of a thermal positive-type or thermal negative-type, for instance, are well-suited for use in computer-to-print (CTP) technology in which digitized image data is carried on a highly convergent beam of radiation such as laser light that is scanned over a presensitized plate to expose it, thus enabling the direct production of a lithographic printing plate without relying on the use of lith film. Accordingly, an image recording layer that is imageable with infrared laser light and can thus be used in such applications is preferred.

These preferred photosensitive compositions are described below.

Thermal Positive-Type Photosensitive Compositions Photosensitive Layer

Thermal positive-type photosensitive compositions contain an alkali-soluble polymeric compound and a photothermal conversion substance. In a thermal positive-type image recording layer, the photothermal conversion substance converts light energy such as that from an infrared laser into heat, which efficiently eliminates interactions that lower the alkali solubility of the alkali-soluble polymeric compound.

The alkali-soluble polymeric compound may be, for example, a resin having an acidic group on the molecule, or a mixture of two or more such resins. Resins having an acidic group, such as a phenolic hydroxyl group, a sulfonamide group (—SO₂NH—R, wherein R is a hydrocarbon group) or an active imino group (—SO₂NHCOR, —SO₂NHSO₂R or —CONHSO₂R, wherein R is as defined above), are especially preferred on account of their solubility in alkali developers.

For an excellent film formability with exposure to light from an infrared laser, for example, resins having phenolic hydroxyl groups are especially desirable. Preferred examples of such resins include novolak resins such as phenol-formaldehyde resins, m-cresol-formaldehyde resins, p-cresol-formaldehyde resins, cresol-formaldehyde resins in which the cresol is a mixture of m-cresol and p-cresol, and phenol/cresol mixture-formaldehyde resins (phenol-cresol-formaldehyde co-condensation resins) in which the cresol is m-cresol, p-cresol or a mixture of m- and p-cresol.

Additional preferred examples include the polymeric compounds mentioned in JP 2001-305722 A (especially paragraphs [0023] to [0042]), the polymeric compounds having recurring units of general formula (1) mentioned in JP 2001-215693 A, and the polymeric compounds mentioned in JP 2002-311570 A (especially paragraph [0107]).

To provide a good recording sensitivity, the photothermal conversion substance is preferably a pigment or dye that absorbs light in the infrared range at a wavelength of 700 to 1200 nm. Illustrative examples of suitable dyes include azo dyes, metal complex salt azo dyes, pyrazolone azo dyes, naphthoquinone dyes, anthraquinone dyes, phthalocyanine dyes, carbonium dyes, quinoneimine dyes, methine dyes, cyanine dyes, squarylium dyes, pyrylium salt and metal-thiolate complexes (e.g., nickel-thiolate complexes). Of these, cyanine dyes are preferred. The cyanine dyes of general formula (I) mentioned in JP 2001-305722 A are especially preferred.

A dissolution inhibitor may be included in thermal positive-type photosensitive compositions. Preferred examples of dissolution inhibitors include those mentioned in paragraphs [0053] to [0055] of JP 2001-305722 A.

The thermal positive-type photosensitive compositions preferably also include, as additives, sensitivity regulators, print-out agents for obtaining a visible image immediately after heating from light exposure, compounds such as dyes as image colorants, and surfactants for enhancing coatability and treatment stability. Compounds such as those mentioned in paragraphs [0056] to [0060] of JP 2001-305722 A are preferred.

Use of the photosensitive compositions described in detail in JP 2001-305722 A is desirable for additional reasons as well.

The thermal positive-type image recording layer is not limited to a single layer, and may have a two-layer construction. Preferred examples of image recording layers with a two-layer construction (also referred to as “multilayer-type image recording layers”) include those of a type provided on the side close to the support with a bottom layer (“layer A”) of excellent press life and solvent resistance, and provided on layer A with a layer (“layer B”) having an excellent positive image-forming ability. This type of image recording layer has a high sensitivity and can provide a broad development latitude. Layer B generally contains a photothermal conversion substance. Preferred examples of the photothermal conversion substance include the dyes mentioned above.

Preferred examples of resins that may be used in layer A include polymers that contain as a copolymerizable ingredient a monomer having a sulfonamide group, an active imino group or a phenolic hydroxyl group; such polymers have an excellent press life and solvent resistance. Preferred examples of resins that may be used in layer B include phenolic hydroxyl group-bearing resins which are soluble in aqueous alkali solutions.

In addition to the above resins, various additives may be included, if necessary, in the compositions used to form layers A and B. For example, suitable use can be made of the additives mentioned in paragraphs [0062] to [0085] of JP 2002-3233769 A. The additives mentioned in paragraphs [0053] to [0060] in JP 2001-305722 A are also suitable for use.

The components and proportions thereof in each of layers A and B may be selected as described in JP 11-218914 A.

Intermediate Layer

It is advantageous to provide an intermediate layer between the thermal positive-type image recording layer and the support. Preferred examples of ingredients that may be used in the intermediate layer include the various organic compounds mentioned in paragraph [0068] of JP 2001-305722 A.

Others

The methods described in JP.2001-305722 A may be used to form a thermal positive-type image recording layer and to manufacture a lithographic printing plate having such a layer.

Thermal Negative-Type Photosensitive Compositions

Thermal negative-type photosensitive compositions contain a curable compound and a photothermal conversion substance. A thermal negative-type image recording layer is a negative-acting photosensitive layer in which areas irradiated with light such as from an infrared laser cure to form image areas.

Polymerizable Layer

An example of a preferred thermal negative-type image recording layer is a polymerizable image recording layer (polymerizable layer). The polymerizable layer contains a photothermal conversion substance, a radical generator, a radical polymerizable compound which is a curable compound, and a binder polymer. In the polymerizable layer, the photothermal conversion substance converts absorbed infrared light into heat, and the heat decomposes the radical generator, thereby generating radicals. The radicals then trigger the chain-like polymerization and curing of the radical polymerizable compound.

Illustrative examples of the photothermal conversion substance include photothermal conversion substances that may be used in the above-described thermal positive-type photosensitive compositions. Specific examples of cyanine dyes, which are especially preferred, include those mentioned in paragraphs [0017] to [0019] of JP 2001-133969 A.

Preferred radical generators include onium salts. The onium salts mentioned in paragraphs [0030] to [0033] of JP 2001-133969 A are especially preferred.

Exemplary radical polymerizable compounds include compounds having one, and preferably two or more, terminal ethylenically unsaturated bonds.

Preferred binder polymers include linear organic polymers. Linear organic polymers which are soluble or swellable in water or a weak alkali solution in water are preferred. Of these, (meth)acrylic resins having unsaturated groups (e.g., allyl, acryloyl) or benzyl groups and carboxyl groups in side chains are especially preferred because they provide an excellent balance of film strength, sensitivity and developability.

Radical polymerizable compounds and binder polymers that may be used include those mentioned specifically in paragraphs [0036] to [0060] of JP 2001-133969 A.

Thermal negative type photosensitive compositions preferably contain additives mentioned in paragraphs [0061] to [0068] of JP 2001-133969 A (e.g., surfactants for enhancing coatability).

The methods described in JP 2001-133969 A can be used to form a polymerizable layer and to manufacture a lithographic printing plate having such a layer.

Acid-Crosslinkable Image Recording Layer

Another preferred thermal negative-type image recording layer is an acid-crosslinkable image recording layer (abbreviated hereinafter as “acid-crosslinkable layer”). An acid-crosslinkable layer contains a photothermal conversion substance, a thermal acid generator, a compound (crosslinker) which is curable and which crosslinks under the influence of an acid, and an alkali-soluble polymeric compound which is capable of reacting with the crosslinker in the presence of an acid. In an acid-crosslinkable layer, the photothermal conversion substance converts absorbed infrared light into heat. The heat decomposes a thermal acid generator, thereby generating an acid which causes the crosslinker and the alkali-soluble polymeric compound to react and cure.

The photothermal conversion substance is exemplified by the same substances as can be used in the polymerizable layer.

Exemplary thermal acid generators include photopolymerization photoinitiators, dye photochromogenic substances, and heat-degradable compounds such as acid generators which are used in-microresists and the like.

Exemplary crosslinkers include hydroxymethyl or alkoxymethyl-substituted aromatic compounds, compounds having N-hydroxymethyl, N-alkoxymethyl or N-acyloxymethyl groups, and epoxy compounds.

Exemplary alkali-soluble polymeric compounds include novolak resins and polymers having hydroxyaryl groups in side chains.

Photopolymer-Type Photosensitive Compositions

Photopolymer-type photosensitive compositions contain an addition polymerizable compound, a photopolymerization initiator and a polymer binder.

Preferred addition polymerizable compounds include compounds having an addition-polymerizable ethylenically unsaturated bond. Ethylenically unsaturated bond-containing compounds are compounds which have a terminal ethylenically unsaturated bond. These include compounds having the chemical form of monomers, prepolymers, and mixtures thereof. The monomers are exemplified by esters of unsaturated carboxylic acids (e.g., acrylic acid, methacrylic acid, itaconic acid, maleic acid) and aliphatic polyols, and amides of unsaturated carboxylic acids and aliphatic polyamines.

Preferred addition polymerizable compounds include also urethane-type addition-polymerizable compounds.

The photopolymerization initiator may be any of various photopolymerization initiators or a system of two or more photopolymerization initiators (photoinitiation system) which is suitably selected according to the wavelength of the light source to be used. Preferred examples include the initiation systems mentioned in paragraphs [0021] to [0023] of JP 2001-22079 A.

The polymer binder, inasmuch as it must both function as a film-forming agent for the photopolymerizable photosensitive composition and must also allow the image recording layer to dissolve in an alkali developer, may be an organic polymer which is soluble or swellable in an aqueous alkali solution. Preferred examples of such organic polymers include those mentioned in paragraphs [0036] to [0063] of JP 2001-22079 A.

It is preferable for the photopolymer-type photopolymerizable photosensitive composition to include the additives mentioned in paragraphs [0079] to [0088] of JP 2001-22079 A (e.g., surfactants for improving coatability, colorants, plasticizers, thermal polymerization inhibitors).

To prevent the inhibition of polymerization by oxygen, it is preferable to provide an oxygen-blocking protective layer on top of the photopolymer-type image recording layer. The polymer present in the oxygen-blocking protective layer is exemplified by polyvinyl alcohols and copolymers thereof.

It is also desirable to provide an intermediate layer or a bonding layer like those described in paragraphs [0124] to [0165] of JP 2001-228608 A.

Conventional Negative-Type Photosensitive Compositions

Conventional negative-type photosensitive compositions contain a diazo resin or a photo-crosslinkable resin. Of these, photosensitive compositions which contain a diazo resin and an alkali-soluble or swellable polymeric compound (binder) are preferred.

The diazo resin is exemplified by the condensation products of an aromatic diazonium salt with an active carbonyl group-bearing compound such as formaldehyde; and organic solvent-soluble diazo resin inorganic salts which are the reaction products of a hexafluorophosphate or tetrafluoroborate with the condensation product of a p-diazophenylamine and formaldehyde. The high-molecular-weight diazo compounds in which the content of hexamer and larger oligomers is at least 20 mol % mentioned in JP 59-78340 A are especially preferred.

Exemplary binders include copolymers containing acrylic acid, methacrylic acid, crotonic acid or maleic acid as an essential ingredient. Specific examples include the multi-component copolymers of monomers such as 2-hydroxyethyl (meth)acrylate, (meth)acrylonitrile and (meth)acrylic acid mentioned in JP 50-118802 A, and the multi-component copolymers of alkyl acrylates, (meth)acrylonitrile and unsaturated carboxylic acids mentioned in JP 56-4144 A.

Conventional negative-type photosensitive compositions preferably contain as additives the print-out agents, dyes, plasticizers for imparting flexibility and wear resistance to the applied coat, the compounds such as development promoters, and the surfactants for enhancing coatability mentioned in paragraphs [0014] to [0015] of JP 7-281425 A.

Below the conventional negative-type photosensitive layer, it is advantageous to provide the intermediate layer which contains a polymeric compound having an acid group-bearing component and an onium group-bearing component described in JP 2000-105462 A.

Conventional Positive-Type Photosensitive Compositions

Conventional positive-type photosensitive compositions contain a quinonediazide compound. Photosensitive compositions containing an o-quinonediazide compound and an alkali-soluble polymeric compound are especially preferred.

Illustrative examples of the o-quinonediazide compound include esters of 1,2-naphthoquinone-2-diazido-5-sulfonylchloride and a phenol-formaldehyde resin or a cresol-formaldehyde resin, and the esters of 1,2-naphthoquinone-2-diazido-5-sulfonylchloride and pyrogallol-acetone resins mentioned in U.S. Pat. No. 3,635,709.

Illustrative examples of the alkali-soluble polymeric compound include phenol-formaldehyde resins, cresol-formaldehyde resins, phenol-cresol-formaldehyde co-condensation resins, polyhydroxystyrene, N-(4-hydroxyphenyl)methacrylamide copolymers, the carboxyl group-bearing polymers mentioned in JP 7-36184 A, the phenolic hydroxyl group-bearing acrylic resins mentioned in JP 51-34711 A, the sulfonamide group-bearing acrylic resins mentioned in JP 2-866 A, and urethane resins.

Conventional positive-type photosensitive compositions preferably contain as additives the compounds such as sensitivity regulators, print-out agents and dyes mentioned in paragraphs [0024] to [0027] of JP 7-92660 A, and surfactants for enhancing coatability such as those mentioned in paragraph [0031] of JP 7-92660 A.

Below the conventional positive-type photosensitive layer, it is advantageous to provide an intermediate layer similar to the intermediate layer which is preferably used in the above-described conventional negative-type photosensitive layer.

Non-Treatment Type Photosensitive Compositions

Illustrative examples of non-treatment type photosensitive compositions include thermoplastic polymer powder-based photosensitive compositions, microcapsule-based photosensitive compositions, and sulfonic acid-generating polymer-containing photosensitive compositions. All of these are heat-sensitive compositions containing a photothermal conversion substance. The photothermal conversion substance is preferably a dye of the same type as those which can be used in the above-described thermal positive-type photosensitive compositions.

Thermoplastic polymer powder-based photosensitive compositions are composed of a hydrophobic, heat-meltable finely divided polymer dispersed in a hydrophilic polymer matrix. In the thermoplastic polymer powder-based image recording layer, the fine particles of hydrophobic polymer melt under the influence of heat generated by light exposure and mutually fuse, forming hydrophobic regions which serve as the image areas.

The finely divided polymer is preferably one in which the particles melt and fuse with other under the influence of heat. A finely divided polymer in which the individual particles have a hydrophilic surface, enabling them to disperse in a hydrophilic component such as dampening water, is especially preferred. Preferred examples include the thermoplastic finely divided polymers described in Research Disclosure No. 33303 (January 1992), JP 9-123387 A, JP 9-131850 A, JP 9-171249 A, JP 9-171250 A and EP 931,647 A. Of these, polystyrene and polymethyl methacrylate are preferred. Illustrative examples of finely divided polymers having a hydrophilic surface include those in which the polymer itself is hydrophilic, and those in which the surfaces of the polymer particles have been rendered hydrophilic by adsorbing thereon a hydrophilic compound such as polyvinyl alcohol or polyethylene glycol.

The finely divided polymer preferably has reactive functional groups.

Preferred examples of microcapsule-type photosensitive compositions include those described in JP 2000-118160 A, and compositions like those described in JP 2001-277740 A in which a compound having thermally reactive functional groups is enclosed within microcapsules.

Illustrative examples of sulfonic acid-generating polymers that may be used in sulfonic acid generating polymer-containing photosensitive compositions include the polymers having sulfonate ester groups in side chains, disulfone groups or sec- or tert-sulfonamide groups described in JP 10-282672 A.

Including a hydrophilic resin in a non-treatment type photosensitive composition not only provides a good on-press developability, it also enhances the film strength of the photosensitive layer itself. Preferred hydrophilic resins include resins having hydrophilic groups such as hydroxyl, carboxyl, hydroxyethyl, hydroxypropyl, amino, aminoethyl, aminopropyl or carboxymethyl groups; and hydrophilic sol-gel conversion-type binder resins.

A non-treatment type image recording layer can be developed on the press, and thus does not require a special development step. The methods described in JP 2002-178655 A can be used as the method of forming a non-treatment type image recording layer and the associated platemaking and printing methods.

Overcoat Layer

In a non-treatment type presensitized plate, a water-soluble overcoat layer can be provided on the above-described image recording layer to protect the surface of the heat-sensitive layer from contamination by oleophilic substances. The water-soluble overcoat layer used in the present invention can be easily removed during printing, and includes a resin selected from among water-soluble organic polymeric compounds.

The water-soluble organic polymeric compound is a substance which, when applied as a coat and dried, has film formability. Specific examples include polyvinyl acetates having a degree of hydrolysis of at least 65%, polyacrylic acids and alkali metal salts or amine salts thereof, polyacrylic acid copolymers and alkali metal salts or amine salts thereof, polymethacrylic acids and alkali metal salts or amine salts thereof, polymethacrylic acid copolymers and alkali metal salts or amine salts thereof, polyacrylamides and copolymers thereof, polyhydroxyethyl acrylates, polyvinylpyrrolidone and copolymers thereof, polyvinyl methyl ethers, maleic anhydride copolymers of polyvinyl methyl ethers, poly(2-acrylamido-2-methyl-1-propanesulfonic acid) and alkali metal salts or amine salts thereof, poly(2-acrylamido-2-methyl-1-propanesulfonic acid) copolymers and alkali metal salts or amine salts thereof, gum arabic, cellulose derivatives (e.g., carboxymethyl cellulose, carboxyethyl cellulose, methyl cellulose) and modified forms thereof, white dextrin, pullulan and enzyme-degraded etherified dextrin. If necessary, two or more of these may be mixed and used together.

The overcoat layer may also have added to it any of the above-described photothermal conversion substances that are water-soluble. Moreover, when the coating fluid used to form the overcoat layer is an aqueous solution, a nonionic surfactant such as polyoxyethylene nonyl phenyl ether or polyoxyethylene dodecyl ether may be added to the overcoat layer to ensure uniformity of application.

The overcoat layer has a coating weight when dry of preferably 0.1 to 2.0 g/m². A weight within this range can provide good protection of the heat-sensitive layer surface from contamination by oleophilic substances, such as fingerprint contamination, without compromising the on-machine developability of the presensitized plate.

Lithographic Platemaking Process

The presensitized plate prepared using a lithographic printing plate support obtainable according to this invention is then rendered into a lithographic printing plate by any of various treatment methods, depending on the type of image recording layer.

Illustrative examples of sources of actinic light that may be used for imagewise exposure include mercury vapor lamps, metal halide lamps, xenon lamps and chemical lamps. Examples of laser beams that may be used include helium-neon lasers (He—Ne lasers), argon lasers, krypton lasers, helium-cadmium lasers, KrF excimer lasers, semiconductor lasers, YAG lasers and YAG-SHG lasers.

Following exposure as described above, when the image recording layer is of a thermal positive type, thermal negative type, conventional negative type, conventional positive type or photopolymer type, it is preferable to carry out development using a liquid developer in order to obtain the lithographic printing plate.

The liquid developer is preferably an alkali developer, and more preferably an alkaline aqueous solution which is substantially free of organic solvent.

Liquid developers which are substantially free of alkali metal silicates are also preferred. One example of a suitable method of development using a liquid developer that is substantially free of alkali metal silicates is the method described in detail in JP 11-109637 A.

Liquid developers which contain an alkali metal silicate can also be used.

If the image recording layer on the presensitized plate of the invention is a non-treatment type layer, following imagewise exposure, the plate can be mounted without further treatment on the printing press and printing carried out by an ordinary procedure using ink and/or dampening water. Moreover, as mentioned in JP 2938398 B, after the plate has been mounted on the plate cylinder of the printing press, it can be exposed using a laser mounted on the press, following which ink and/or dampening water can be applied and on-machine development carried out. In such cases, because the heat-sensitive layer is removed on the press by the ink and/or dampening water, there is no need for a separate development operation. Moreover, once development is over, printing can begin without stopping the press; that is, printing can be carried out immediately without interruption once development is complete.

A plate having a non-treatment type heat-sensitive layer can be used in printing after it has been developed with water or a suitable aqueous solution as the developer.

### EXAMPLES

Examples are given below by way of illustration and not by way of limitation.

1. Fabrication of Lithographic Printing Plate Support

### Example 1

Aluminum Sheet

A melt was prepared from an aluminum alloy composed of 0.06 wt % silicon, 0.30 wt % iron, 0.005 wt % copper, 0.001 wt % manganese, 0.001 wt % magnesium, 0.001 wt % zinc and 0.03 wt % titanium, with the balance being aluminum and inadvertent impurities. The aluminum alloy melt was subjected to molten metal treatment and filtration, then was cast into a 500 mm thick, 1,200 mm wide ingot by a direct chill casting method. The ingot was scalped with a scalping machine, removing an average of 10 mm of material from the surface, then soaked and held at 550° C. for about 5 hours. When the temperature had fallen to 400° C., the ingot was rolled with a hot rolling mill to a thickness of 2.7 mm. In addition, heat treatment was carried out at 500° C. in a continuous annealing furnace, following which cold rolling was carried out to a final thickness of 0.24 mm, thereby giving a sheet of JIS 1050 aluminum. Cold rolling was carried out with a metal-rolling roll having on the surface convex portions with a pitch of 12 μm, thereby rolling the sheet at a rolling reduction of 10% and forming concave portions on the aluminum surface. The resulting aluminum sheet was cut to a width of 1,030 mm, then subjected to surface treatment as described below.

Surface Treatment

The aluminum sheet was successively subjected to the following surface treatments (a) to (g). After each treatment and subsequent rinsing with water, liquid was removed from the sheet with nip rollers.

(a) Alkali Etching

Etching was carried out by spraying the aluminum sheet obtained as described above with an aqueous solution having a sodium hydroxide concentration of 26 wt %, an aluminum ion concentration of 6 wt % and a temperature of 60° C., thereby dissolving 3 g/m² of material from the aluminum sheet. The etched sheet was then rinsed by spraying it with water.

(b) Desmutting

Desmutting was carried out by spraying the aluminum sheet for 10 seconds with a 35° C. aqueous solution having a nitric acid concentration of 1 wt % and containing 1 wt % of aluminum ions, then rinsing the sheet by spraying it with water.

(c) Hydrochloric Acid Electrolysis

Electrochemical graining treatment was then successively carried out using 60 Hz AC power. The electrolyte was a 1 wt % solution of hydrochloric acid in water which also contained 0.5 wt % of aluminum ions and had a temperature of 35° C. The waveform shown in FIG. 2 was used as the AC power supply waveform. The time TP until the current reached a peak from zero was 0.8 ms, and the duty ratio was 1:1. Electrochemical graining treatment was carried out using a trapezoidal square wave alternating current, and using a carbon electrode as the counterelectrode. Ferrite was used as the auxiliary anodes. An electrolytic cell of the type shown in FIG. 3 was used.

In electrochemical graining treatment, the current density expressed at the peak current value was 20 A/dm², and the total amount of electricity when the aluminum sheet served as the anode was 60 C/dm². Also, 5% of the current from the power supply was diverted to the auxiliary anodes.

The electrolyzed sheet was then rinsed by spraying it with water.

(d) Alkali Etching

Etching was carried out by spraying the aluminum sheet obtained as described above with an aqueous solution having a sodium hydroxide concentration of 26 wt %, an aluminum ion concentration of 7 wt % and a temperature of 60° C., thereby dissolving 0.2 g/m² of material from the aluminum sheet. The etched sheet was then rinsed by spraying it with water.

(e) Desmutting

Desmutting was carried out by spraying the aluminum sheet for 10 seconds with a 35° C. aqueous solution having a nitric acid concentration of 1 wt % and containing 0.5 wt % of aluminum ions, then rinsing the sheet by spraying it with water.

(f) Anodizing Treatment

Anodizing treatment was carried out using an anodizing machine of the construction shown in FIG. 4. Sulfuric acid was used as the electrolyte fed to the first and second electrolyzing sections. The electrolyte fed to both sections had a sulfuric acid concentration of 15 wt %, an aluminum ion content of 1 wt %, and a temperature of 35° C. The anodized sheet was then rinsed by spraying it with water. The final anodized layer had a weight of 2.7 g/m².

(g) Hydrophilizing Treatment

Hydrophilizing treatment was carried out by immersing the aluminum sheet for 10 seconds in a 35° C. water solution of No. 3 sodium silicate (Na₂O:SiO₂=1:3; SiO₂ content, 30 wt %; produced by Nippon Chemical Industrial Co., Ltd.; concentration, 1 wt %). The amount of silicon on the surface of the aluminum sheet, as measured by a fluorescent x-ray analyzer, was 3.5 mg/m². The hydrophilized sheet was then rinsed by spraying it with water, thereby completing production of a lithographic printing plate support.

### Example 2

Aside from setting the rolling reduction in cold rolling during production of the aluminum sheet to 8%, a lithographic printing plate support was obtained by the same method as in Example 1.

### Example 3

Aside from setting the rolling reduction in cold rolling during production of the aluminum sheet to 5%, a lithographic printing plate support was obtained by the same method as in Example 1.

### Example 4

Aside from setting the etching amount in the above-described alkali etching treatment step (a) to 7 g/m², a lithographic printing plate support was obtained by the same method as in Example 1.

### Example 5

Aside from setting the etching amount in the above-described alkali etching treatment step (a) to 5 g/m², a lithographic printing plate support was obtained by the same method as in Example 1.

### Example 6

Aside from using a metal-rolling roll having on the surface thereof convex portions with a pitch of 10 μm to carry out cold rolling during production of the aluminum sheet, a lithographic printing plate support was obtained by the same method as in Example 1.

### Example 7

Aside from using a metal-rolling roll lacking convex portions on the surface to carry out cold rolling during production of the aluminum sheet and carrying out step (h) below prior to above step (a), a lithographic printing plate support was obtained by the same method as in Example 1.

(h) Nitric Acid Electrolysis

Electrochemical graining treatment was carried out using 0.125 Hz AC power. The electrolyte was a 1 wt % water solution of nitric acid which also contained 0.5 wt % of aluminum ions and 80 ppm of ammonium ions, and had a temperature of 35° C. The waveform shown in FIG. 2 was used as the AC power supply waveform. The time TP until the current reached a peak from zero was 0.8 ms, and the duty ratio was 1:1. Electrochemical graining treatment was carried out using a trapezoidal square wave alternating current, and using a carbon electrode as the counterelectrode. Ferrite was used as the auxiliary anodes. An electrolytic cell of the type shown in FIG. 3 was used.

In electrochemical graining treatment, the current density at the peak current value was 50 A/dm², and the total amount of electricity when the aluminum sheet served as the anode was 400 C/dm². Also, 5% of the current from the power supply was diverted to the auxiliary anodes.

The electrolyzed sheet was then rinsed by spraying it with water.

### Example 8

Aside from setting the etching amount in the above-described alkali etching treatment step (a) to 10 g/m², a lithographic printing plate support was obtained by the same method as in Example 1.

### Example 9

Aside from setting the etching amount in the above-described alkali etching treatment step (a) to 12 g/m², a lithographic printing plate support was obtained by the same method as in Example 1.

### Comparative Example 1

Aside from setting the rolling reduction in cold rolling during production of the aluminum sheet to 3%, a lithographic printing plate support was obtained by the same method as in Example 1.

### Comparative Example 2

Aside from using a metal-rolling roll lacking concave portions on the surface to carry out cold rolling during production of the aluminum sheet, carrying out step (i) below prior to above step (a), and setting the etching amount in the above-described alkali etching treatment step (a) to 10 g/m², a lithographic printing plate support was obtained by the same method as in Example 1.

(i) Mechanical Graining

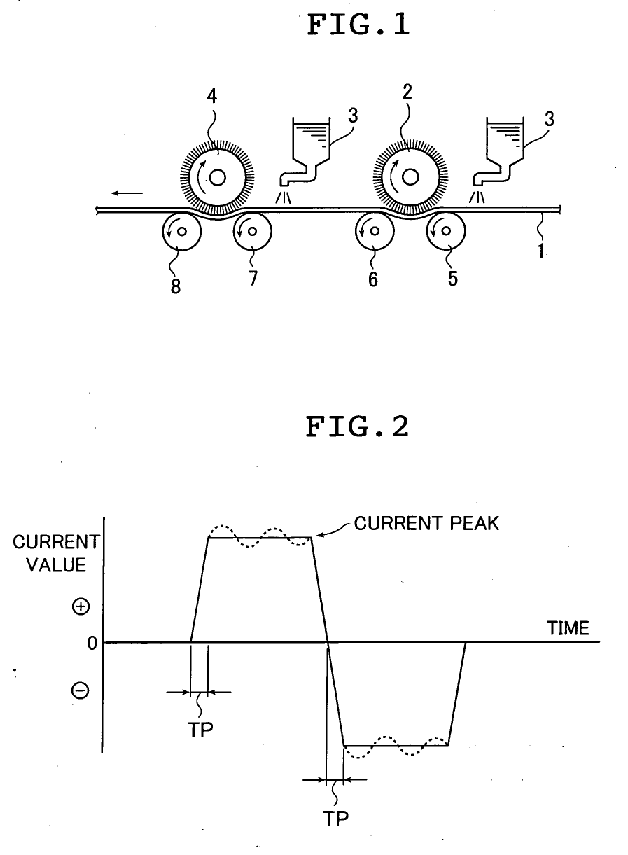

Using an apparatus like that shown in FIG. 1, mechanical graining treatment was carried out with roller-type nylon brushes while feeding an abrasive slurry consisting of a suspension of pumice in water (specific gravity of suspension, 1.12). FIG. 1 shows an aluminum sheet 1, roller-type brushes 2 and 4, an abrasive slurry 3, and support rollers 5, 6, 7 and 8. The abrasive had an average particle size of 20 μm. The nylon brush was made of nylon 6/10 and had a bristle length of 50 mm and a bristle diameter of 0.5 mm (No. 8). The nylon brushes were 300 mm diameter stainless steel cylinders in which holes had been formed and bristles densely set therein. Three rotating brushes were used. Two support rollers (200 mm diameter) were situated below the brushes and spaced 300 mm apart. The brush rollers were pressed against the aluminum sheet until the load on the driving motor that rotates the brushes was 7 kW greater than before the brush rollers were pressed against the sheet. The direction of rotation by the brushes was the same as the direction of movement by the aluminum sheet. The speed of rotation by the brushes was 250 rpm.

Aside from using a metal-rolling roll lacking concave portions on the surface to carry out cold rolling during production of the aluminum sheet, carrying out step (j) below prior to above step (a), setting the etching amount in the above-described alkali etching treatment step (a) to 0.5 g/m², and not carrying out above steps (c) to (e), a lithographic printing plate support was obtained by the same method as in Example 1.

(j) Hydrochloric Acid Electrolysis

Electrochemical graining treatment was then successively carried out using 60 Hz AC power. The electrolyte was a 1 wt % water solution of hydrochloric acid which also contained 0.5 wt % of aluminum ions and 80 ppm of ammonium ions, and had a temperature of 35° C. The waveform shown in FIG. 2 was used as the AC power supply waveform. The time TP until the current reached a peak from zero was 0.8 ms, and the duty ratio was 1:1. Electrochemical graining treatment was carried out using a trapezoidal square wave alternating current, and using a carbon electrode as the counterelectrode. Ferrite was used as the auxiliary anodes. An electrolytic cell of the type shown in FIG. 3 was used.

In electrochemical graining treatment, the current density at the peak current value was 50 A/dm², and the total amount of electricity when the aluminum sheet served as the anode was 400 C/dm². Also, 5% of the current from the power supply was diverted to the auxiliary anodes.

The electrolyzed sheet was then rinsed by spraying it with water.

### Comparative Example 4

Aside from changing the amount of electricity in the foregoing hydrochloric acid electrolysis step (j) so that the total amount of electricity when the aluminum sheet served as the anode was 600 C/dm², a lithographic printing plate support was obtained by the same method as in Comparative Example 3.

2. Computation of Surface Shape Factors for Lithographic Printing Plate Support

(1) Surface Shape Using Three-Dimensional Non-Contact Surface Roughness Tester

A 400 μm×400 μm region on the surface of the lithographic printing plate support was scanned without contact at a resolution of 0.01 μm using a three-dimensional non-contact roughness tester (Micromap 520, manufactured by Ryoka Systems Inc.), thereby obtaining three-dimensional data. Using software (SX Viewer, produced by Ryoka Systems Inc.), this three-dimensional data was converted to binary values and subjected to image analysis to determine the number of convex portions having a height from centerline of at least 0.70 μm and an equivalent circle diameter of at least 20 μm and the number of concave portions having a depth from centerline of at least 0.50 μm and an equivalent circle diameter of at least 2.0 μm. Measurement was carried out at five places on a sample, and the average of the measurements on the sample was determined.

(2) Surface Shape Using Atomic Force Microscope

To determine the surface area ratio ΔS⁵⁰, the surface shape of the lithographic printing plate support was measured with an atomic force microscope (SPA300/SPI3800N, manufactured by Seiko Instruments, Inc.), thereby obtaining three-dimensional data.

A square piece measuring 1 cm×1 cm was cut from the lithographic printing plate support and placed on a horizontal sample holder mounted on a piezo scanner. A cantilever was then approached to the surface of the sample. Once the cantilever reached the region where interatomic forces were appreciable, it scanned the surface of the sample in the XY direction, reading off the surface topography of the sample based on the piezo displacement in the Z direction. A piezo scanner capable of scanning 150 μm in the XY direction and 10 μm in the Z direction was used. A cantilever having a resonance frequency of 120 to 400 kHz and a spring constant of 12 to 90 N/m (e.g., SI-DF20, manufactured by Seiko Instruments, Inc.) was used, with measurement being carried out in the dynamic force mode (DFM). The three-dimensional data thus obtained was least-squares approximated to correct for slight tilting of the sample and a reference plane was created.

Measurement involved obtaining values at 512 by 512 points over a 50 μm×50 μm region on the sample surface. The resolution was 0.1 μm in the XY direction, and 0.15 nm in the Z direction. The scan rate was set at 50 μm/s.

Using the three-dimensional data (f(x,y)) data obtained as described above, sets of three mutually neighboring points were selected and the sum of the surface areas of the microtriangles formed by the sets of three points was determined, from which the true surface area Sₓ⁵⁰ was obtained. Formula (1) above was used to obtain the surface area ratio ΔS⁵⁰ from the resulting true surface area Sₓ⁵⁰ and the geometrically measured surface area S₀⁵⁰.

3. Fabrication of Presensitized Plate

In each example, a presensitized plate for lithographic printing was fabricated by providing a thermal positive-working image recording layer in the manner described below on the lithographic printing plate supports obtained above. Before providing the image recording layer, an undercoat was formed as follows on the support.

Formation of Undercoat

An undercoating solution of the composition indicated below was applied onto the lithographic printing plate support following silicate treatment and dried at 80° C. for 15 seconds, thereby forming an undercoat. The weight of the undercoat after drying was 10 mg/m².

Composition of Undercoating Solution

| | |
|---|---|
| Polymeric compound of the following formula | 0.2 g |
| 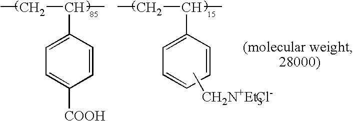 | |
| Methanol | 100 g |
| Water | 1 g |

Formation of Image Recording Layer

Next, a single layer-type thermal positive-working image recording layer was formed as follows.

An image recording layer-forming coating solution of the following composition was prepared. This solution was applied onto the undercoated lithographic printing plate support to a coating weight when dry (heat-sensitive layer coating weight) of 1.7 g/m² and dried so as to form a single layer-type thermal positive-working image recording layer, thereby giving a presensitized plate.

Composition of Heat Sensitive Layer-Forming Coating Solution

| | |
|---|---|
| Novolak resin (m-cresol/p-cresol = 60/40; weight-average | 1.0 g |
| molecular weight, 7,000; unreacted cresol content, 0.5 wt %) | |
| Cyanine dye A of the following formula | 0.1 g |
| 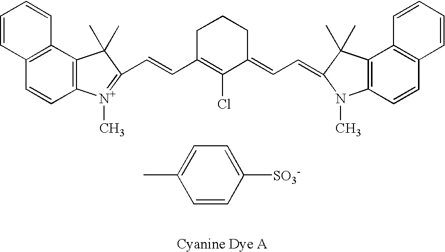 | |
| Tetrahydrophthalic anhydride | 0.05 g |
| p-Toluenesulfonic acid | 0.002 g |
| Ethyl violet in which counterion was changed to | 0.02 g |
| 6-hydroxy-β-naphthalenesulfonic acid | |
| Fluorocarbon surfactant (Megafac F-177, | 0.05 g |
| available from Dainippon Ink & Chemicals | |
| Methyl ethyl ketone | 12 g |

4. Exposure and Development

The presensitized plates obtained as described above were image exposed and developed in the manner indicated below, giving lithographic printing plates.

In each example, the presensitized plate was imagewise exposed using a Trendsetter 3244 (Creo Inc.) equipped with a semiconductor laser having an output of 500 mW, a wavelength of 830 nm and a beam diameter of 17 μm (1/e²) at a main scan rate of 5 m/s and a plate surface energy of 140 mJ/cm².

Next, the exposed plate was developed with an alkali developer (Developer 1) prepared by adding 1.0 g of Cl₂H₂₅N (CH₂CH₂COONa)₂ to one liter of an aqueous solution containing 5.0 wt % of a potassium salt composed of D-sorbit/potassium oxide K₂O (a combination of a non-reducing sugar and a base) and 0.015 wt % of Olfine AK-02 (Nissin Chemical Industry Co., Ltd.). Development was carried out at a temperature of 25° C. for 12 seconds using a PS900NP automated processor (manufactured by Fuji Photo Film Co., Ltd.) filled with Developer 1. After development was completed, the developed plate was rinsed with water, then treated with a gum (GU-7 (1:1)) or the like, thereby giving a completed lithographic printing plate.

5. Evaluation of Presensitized Plates

The presensitized plates obtained as described above were evaluated for press life and scumming resistance as follows. (1) Press Life

The press life was evaluated by printing copies from the printing plate on a Sprint printing press (manufactured by Komori Corporation) using DIC-GEOS (N) India ink (Dainippon Ink & Chemicals, Inc.) and determining the total number of copies that were printed up until the density of solid images began to noticeably decline on visual inspection. The results are shown in Table 1.

(2) Scumming Resistance (Toning)

The scumming resistance was evaluated by visually inspecting the blanket roller for scumming (toning) after 10,000 impressions had been printed on a Mitsubishi Daiya F2 printing press (Mitsubishi Heavy Industries, Ltd.) using LeoEcoo purple ink (Toyo Ink Mfg. Co., Ltd.).

The printing plates obtained in all the examples of the invention and the comparative examples were found to have good scumming resistances.

As is apparent from the results in Table 1, the lithographic printing plate supports according to the invention (Examples 1 to 9) all had excellent press lives. Of these, the plates having a large surface area ratio ΔS⁵⁰ (Examples 1 to 7) exhibited particularly long press lives.

By contrast, the press life was not as good in cases where the number of convex portions having a height of at least 0.70 μm and an equivalent circle diameter of at least 20 μm was too large (Comparative Examples 1 and 2) or the number of concave portions having a depth of at least 0.50 μm and an equivalent circle diameter of at least 2.0 μm was too small (Comparative Examples 3 and 4).

TABLE 1

| | Number of convex | Number of concave | | |
|---|---|---|---|---|
| | portions with | portions with | | |
| | height of ≧0.70 μm | depth of ≧0.50 μm | | |
| | and equivalent | and equivalent | | Press life |
| | circle | circle | ΔS⁵⁰ | (1,000's of |
| | diameter of ≧20 μm | diameter of ≧2.0 μm | (%) | impressions) |
| EX 1 | 0.0 | 1,133 | 45 | 65 |
| EX 2 | 2.2 | 1,080 | 46 | 61 |
| EX 3 | 4.9 | 956 | 48 | 46 |
| EX 4 | 3.2 | 813 | 38 | 43 |
| EX 5 | 2.2 | 982 | 46 | 49 |
| EX 6 | 4.6 | 1,511 | 32 | 58 |
| EX 7 | 1.5 | 982 | 80 | 52 |
| EX 8 | 2.7 | 1,248 | 29 | 42 |
| EX 9 | 1.8 | 1,044 | 15 | 41 |
| CE 1 | 6.5 | 1,055 | 50 | 38 |
| CE 2 | 10.2 | 896 | 43 | 25 |
| CE 3 | 2.8 | 780 | 47 | 36 |
| CE 4 | 3.1 | 561 | 39 | 34 |

1. A support for a lithographic printing plate which, when measured over a 400 μm×400 μm surface region thereon using a three-dimensional non-contact roughness tester, has at most 5.0 convex portions of a height from centerline of at least 0.70 μm and an equivalent circle diameter of at least 20 μm, and has at least 800 concave portions of a depth from centerline of at least 0.50 μm and an equivalent circle diameter of at least 2.0 μm.

2. The support for a lithographic printing plate according to claim 1 which has a surface area ratio ΔS⁵⁰ defined by formula (1) below
ΔS⁵⁰=(Sₓ⁵⁰−S₀⁵⁰)/S₀⁵⁰×100(%) (1),
wherein Sₓ⁵⁰ is a true surface area of a 50 μm×50 μm surface region as determined by three-point approximation from three-dimensional data obtained by measurement with an atomic force microscope at 512×512 points over the surface region and S₀⁵⁰ is a geometrically measured surface area of the surface region, of 30 to 80%.

3. A presensitized plate, which comprises the support for a lithographic printing plate according to claim 1 and an image recording layer thereon.

4. A presensitized plate, which comprises the support for a lithographic printing plate according to claim 2 and an image recording layer thereon.
